(19) United States
(12) Patent Application Publication
(10) Pub. No.: US 2013/0236007 A1
(43) Pub. Date: Sep. 12, 2013

(54) METHODS FOR CREATING SECRET KEYS USING RADIO AND DEVICE MOTION AND DEVICES THEREOF

(71) Applicant: DIGITAL LOBE, LLC, Fairport, NY (US)

(72) Inventors: James F. Munro, Ontario, NY (US); Peter M. Hammond, Rochester, NY (US)

(73) Assignee: DIGITAL LOBE, LLC, Fairport, NY (US)

(21) Appl. No.: 13/782,837

(22) Filed: Mar. 1, 2013

Related U.S. Application Data
(60) Provisional application No. 61/634,836, filed on Mar. 7, 2012.

(51) Int. Cl. H04L 9/08

(52) U.S. Cl. CPC H04L 9/0861
USPC 380/44

(57) ABSTRACT

A method and system for generating one or more keys includes obtaining at two or more devices data based on movement of at least one of the devices with the respect to the other device. An RF signal sent from each of the one or more of the devices to the other devices is used to generate data that changes in accordance with the movement of the one or more devices. At least one key is generated based on the obtained data at each of the devices for use in securing communications between the devices. The key at each of the devices is substantially the same.

This application claims the benefit of U.S. Provisional Patent Application Ser. No. 61/634,836 filed Mar. 7, 2012, which is hereby incorporated by reference in its entirety.

### FIELD OF THE INVENTION

The present invention generally relates to methods and devices for cryptographic communications and, more particularly, to methods and devices for simultaneously and independently generating with radio at least one secret key used for encryption and message integrity checking upon data sent between two electronic devices based on measurements of a change in a distance between the devices.

### BACKGROUND

A recurring problem in symmetric cryptography is the distribution of secret keys. Secret keys are required for symmetric encryption and decryption of messages transmitted over an insecure medium, such as over a wireless radio link or over the Internet. In electronic communications, secret keys are also used to provide a secure integrity check that ensures messages have not been modified during transmission. In addition, electronic communication systems also routinely use knowledge of secret keys to demonstrate proof of identity (authentication).

Unfortunately, it is problematic to distribute a secret key over a communication channel before that communication channel has been secured. The paradox is that the communication channel cannot be secured until the secret key has been distributed—this is the “chicken and egg” problem for symmetric encryption systems. Two methods are in common commercial use for avoiding this problem.

The first commonly-used method of solving the key distribution problem is to switch to a public-key encryption system and avoid the distribution of secret keys. Each party in a public-key communication scheme has two keys: a public key that may be widely known and a private key that is known only to the appropriate party. To communicate with another party, the transmitting party need only have knowledge of the recipient's public key. The recipient is responsible for keeping its private key safe. Public-key cryptography partially solves the initial key distribution problem that plague symmetric encryption algorithms, but the algorithms used for public-key encryption and decryption are computationally intensive. It is not uncommon to see a public-key algorithm operate 100 times slower than a symmetric key algorithm. Public-key algorithms also have limitations on the size of each transmitted message, while these limitations are not generally found in symmetric encryption algorithms.

The second commonly-used method of solving the key distribution problem is to have the communication parties jointly agree upon a secret key without transmitting the secret key over the unsecured communication channel. Several algorithms are available and in wide use in commercially-available electronic communication systems today. Most of these algorithms are based upon the infeasibility of performing some types of mathematical operations, such as computing the discrete logarithm of a very large number containing hundreds of digits. In other words, the strength of the key agreement algorithm rests upon the assumption that it is computationally infeasible for an attacker to bypass the algorithm. Because the algorithms are mathematically-based, the possibility exists that a simpler solution may exist, some day be discovered, and be employed. This outcome would negate the effectiveness of the algorithm and thus this method.

Therefore a need exists for a simple low-cost means of securing a communication channel without the use of public keys or by using a computationally expensive algorithm. This need is becoming ever more acute with the wide distribution of mobile devices that carry proprietary information, like credit card data, that from time to time needs to be transmitted securely to a terminal device, such as a point of sale terminal. It is also desirable to take advantage of the Bluetooth radio communication standard, whose hardware is becoming increasingly prevalent on a wide variety or mobile devices.

### SUMMARY

A method for generating one or more keys at one or more devices in accordance with embodiments of the present invention includes transmitting a signal from the devices, receiving at each device a signal transmitted from the other device, processing the received signal at each device to obtain data based on movement of the device with respect to the other device, and generating one or more keys at the two or more devices from the obtained data wherein the one or more keys at each of the devices are substantially the same.

A device that generates one or more keys at one or more devices in accordance with embodiments of the present invention includes a transmitter, a receiver, a data acquisition system, a digital processor, wherein signals transmitted from the devices are received at the other devices, and data is acquired from the received signal at each device that varies in accordance with movement of the device with respect to the other device, and generating one or more keys at the two or more devices from the obtained data wherein the one or more keys at each of the devices are substantially the same.

In accordance with other embodiments of the present invention, identical sequences of keying material are created which are suitable for the establishment of a secure data communication channel based upon a change in movement or position between the communicating devices. The bits for the key are generated from a plurality of phase measurements of a radio signal sent between the devices, from which a number of measurements equal to a number of desired key bits are generated after averaging and filtering the phase data. By way of example, a common number of key bits is 128 so to generate those key bits a sufficient number of discrete phase measurements are required that yield 128 bits, although other numbers of key bits can be generated. The phase measurements are then converted to Δ-Phase values, which are then converted from a floating point number to an integer data type. Next, a bit is selected from each integer Δ-Phase measurement that is not influenced by measurement noise and has a measurably random value. This bit is used as a key bit. A string of such key bits are selected from the measurements to be used as the secret key. Since the measurement setup and the process employed to generate the key bits is common to the two or more devices, the devices will independently arrive at the same secret key.

Accordingly, the present invention provides an effective and secure method and system for simultaneously and independently generating one or more secret keys for encrypting and decrypting data sent between devices based on measurements of a radio signal that changes in accordance with the relative motion between the devices. The present invention also is an effective and secure method for simultaneously and independently generating one or more secret keys that provide for secure message integrity checks on data transmitted between devices. These generated secret keys can be used in standard cryptographically-secure communication schemes.

### BRIEF DESCRIPTION OF THE DRAWINGS

FIG. 1 is a block diagram of a system for independently generating one or more keys at two or more devices in accordance with embodiments of the present invention;

FIG. 2A is a perspective view of a fixed position device and a mobile (i.e., non-fixed position) device illustrating their orientations and emissions;

FIG. 2B is a perspective view of the mobile device and the fixed position device illustrating a radio signal path while the mobile device is in motion;

FIG. 2C is a view of the fixed position device and several mobile devices illustrating the radio signal paths of the devices and motion of the mobile devices;

FIG. 3A is a graph of distance between the fixed position device and the non-fixed position device as a function of time during a single swipe or pass;

FIG. 3B is a graph of distance between the fixed position device and the non-fixed position device as a function of time during a double swipe or pass;

FIG. 4 is a block diagram of the signal processing that occurs within a system for generating one or more keys at two or more devices in accordance with embodiments of the present invention;

FIG. 5 is a graph illustrating how well a series of noisy data samples can be fit to a sinusoid by using a Gauss-Newton nonlinear regression algorithm;

FIG. 6 is a diagram illustrating the contents of the real and imaginary output bins created by a Discrete Fourier Transform algorithm;

FIG. 7A is a graph of raw sampled signal data as a function of time for comparison to subsequent graphs of “stretched” data for centroiding and zero-crossing algorithms;

FIG. 7B is a graph of sampled data that has been squared, i.e., the data values multiplied by themselves, to facilitate the operation of a centroiding algorithm for determining the phase and/or frequency of an unknown sampled sinusoid;

FIG. 7C is a graph of sampled data wherein the data values have been multiplied by themselves to the fourth power, to facilitate the operation of a centroiding algorithm for determining the phase and/or frequency of an unknown sampled sinusoid;

FIG. 8 is a close-up of the area of the first zero-crossing location of the sampled data of FIG. 7A;

FIG. 9 is a table of intermediate data used to generate bits from which the secret key is generated;

FIG. 10 is a table of bits with regions of noisy bits, measurably random bits, deterministic non-random bits, and zero bits;

FIG. 11A is a timing diagram of the emissions of the fixed position device and the non-fixed position device wherein the transmit and receive frequencies are substantially the same;

FIG. 11B is a timing diagram of the emissions of the fixed position device and the non-fixed position device wherein the emission frequencies of the fixed position device and the non-fixed position device are different;

FIG. 11C is a timing diagram of the emissions of the fixed position device and the non-fixed position device wherein there are several distinct emission frequencies;

FIG. 12 is a flowchart of a method for independently generating one or more keys at two or more devices in accordance with other embodiments of the present invention;

FIG. 13 is a top-view of the fixed position device enclosed in an opaque housing and movable with a cam system in another system for generating one or more keys in accordance with other embodiments of the present invention;

FIG. 14 is a top-view of the fixed position device enclosed in an opaque housing and movable with an actuator in another system for generating one or more keys in accordance with other embodiments of the present invention, and

FIG. 15 is an alternate embodiment of a fixed position device in which there are two or more antennae.

### DETAILED DESCRIPTION

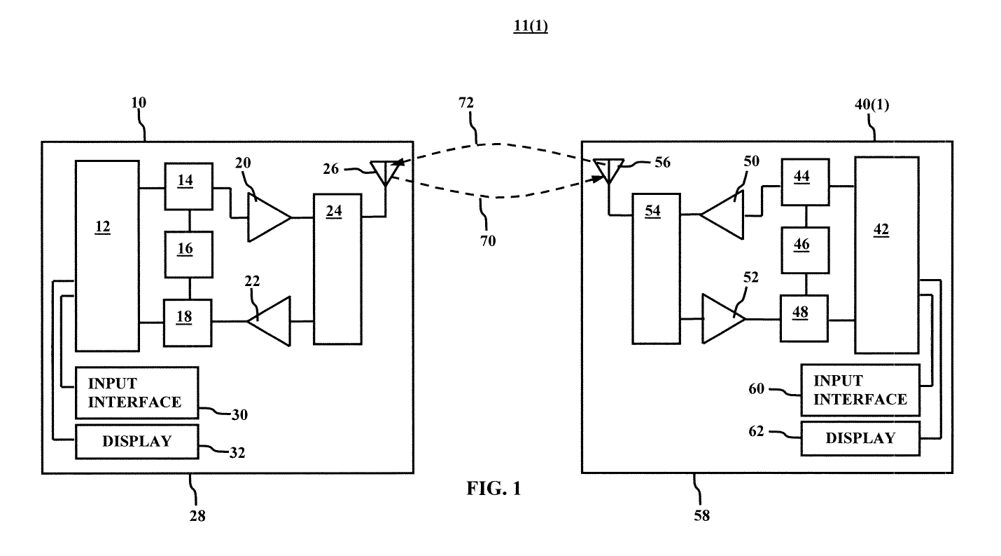

A system 11(1) for generating one or more secret keys in accordance with embodiments of the present invention is illustrated in FIG. 1. The system includes a fixed position device 10 with a transmission system, a reception system, and a processing device 12, and a non-fixed position or mobile device 40(1) with a transmission system, a reception system, and a processing device 42, although the system 11(1) can include other types and numbers of components, devices, and/or systems configured in other manners. Accordingly, the present invention provides an effective and secure method and system for simultaneously and independently generating key material suitable for securing data sent between a fixed device 10 and a mobile device 40(1) based on measurements of a received radio signal that vary in accordance with motion of a mobile device 40(1) relative to the fixed device 10.

Referring more specifically to FIG. 1, the fixed position device 10 is a system that generates one or more secret keys independently and substantially simultaneously with the mobile device 40(1) based on phase measurements of radio signals sent between the fixed position device 10 and the mobile device 40(1), although other types and numbers of systems and devices which measure other characteristics could be used.

In this particular embodiment, the fixed position device 10 is a point-of-sale (POS) terminal, although other types and numbers of devices could be used, such as a desktop computer, a docking station, a ground station, an electronic lock, or any other device that is nominally fixed in position. Alternately, the “fixed” site can also be mobile or portable, such as a memory device, MP3 player, cell-phone, PDA, or key fob. Additionally, in this particular embodiment the emissions used by the fixed position device 10 to measure changes in phase are electromagnetic, although other numbers and types of emissions such as acoustic, magnetic, or electrostatic, could be used. In particular, the electromagnetic emission is of radio frequency, particularly in that part of the spectrum occupied by those frequencies used in the Bluetooth protocol.

The fixed position device 10 includes a housing 28 with a transmission system that includes a transmitter 20, a T/R (transmitter/receiver) isolator 24, an antenna 26, a receiver system that includes a T/R isolator 24, receiving amplifier 22, and antenna 26, as well as timing generator 16 (also known as a clock), transmitter signal generator 14, a demodulator 18, a digital processor 12, an operator input interface 30, and a display 32, although other types and numbers of system components can be used, or omitted. The antenna 26 can be split into separate transmitting and receiving antennae. Alternately, in an optical embodiment, the radio transmitter 20 and antenna 26 can be replaced with a source of optical radiation such as an LED or laser, and the antenna 26 can be replaced with a photodetector, such as an APD or PIN diode.

In this embodiment, the energy 70 and 72 transmitted between the devices 10 and 40(1) is electromagnetic radio waves, although other types and numbers of energy emitters could be used which emit in other frequencies of electromagnetic energy, such as optical. By way of example only, other types of emissions which could be used are acoustic, magnetic, electrostatic, or a hybrid of two or more of these. The carrier frequency of the electromagnetic radio energy can be in the radio frequency (RF) portion of the spectrum or in the millimeter-wave (MMW), microwave, infrared (IR), visible, or ultraviolet (UV) parts of the spectrum.

In this particular embodiment, the timing generator 16 is coupled to the transmitter signal generator 14 which is also coupled to, and receives signals from, the digital processor 12. The output of the transmitter signal generator 14 is then input to the transmitter 20, whose output in turn is connected to an input of the T/R isolator 24. The radio output of the T/R isolator 24 is directed to the antenna 26 for transmission of the radio emission 70 over the air.

The antenna 26 in this example also doubles as a receiving antenna whose output is connected to the T/R isolator 24. The received signal output by the T/R isolator 24 is directed to a receiving amplifier 22, whose output is then connected to an input of the demodulator 18. Demodulator 18 also has as an input frequency signals output by the timing generator 16. Demodulated signals output by the demodulator 18 are then input to the digital processor 12, that in turn also accepts inputs from the operator input interface 30, and also outputs information to the display 32. The digital processor 12 also has an output that is connected to the input of the transmitter signal generator 14.

The timing generator 16 is typically an oscillator that uses a crystal as its frequency standard, although other configurations based upon a temperature compensated crystal oscillator (TCXO), or even an atomic clock, are possible. The timing generator 16 may also include dividing circuits, digital-locked loops (DLL's), or phase-locked-loops (PLL's) to allow for multiple frequencies to be available from a single oscillator under the control of the digital processor 12. The outputs from the timing generator 16 are typically digital. The output from the timing generator 16 that is connected to the input of the transmitter signal generator 14 is at a frequency that is substantially the same as the radio frequency emission 70 that is emitted by the antenna 26, although other configurations and frequencies can be used.

The transmitter signal generator 14 is a digital circuit that accepts as inputs signals output by the digital processor 12 and the timing generator 16. When the devices 10 and 40(1) are in Sync mode, in which the devices are sending synchronization and handshaking signals, the transmitter signal generator receives commands from the digital processor 12 that determining which handshaking or synchronization signal is to be sent. The signal generator 14 then outputs the handshake or synchronization signal to be sent to the mobile device 40(1), via the transmitter 20, T/R isolator 24, and antenna 26, at the appropriate time and rate. When the devices 10 and 40(1) are in Measurement Mode, in which the swipe profile is being measured, the transmitter signal generator 14 routes the output signal from the timing generator 16 to the input of the transmitter 20. When the devices 10 and 40(1) are in Data Mode, in which data is being sent between the devices 10 and 40(1), data to be sent from the fixed device 10 is output by the digital processor 12 to an input of the signal generator 14 for storage and buffering. The signal generator 14 then outputs the data to be sent to the mobile device 40(1), via the transmitter 20, T/R isolator 24, and antenna 26, at the appropriate time and rate. That is, the signal generator 14 has internal memory that operates in a FIFO (first-in-first-out) mode to allow for buffering of data to be transmitted as required, although other modes of operation in other configurations are possible as well.

The transmitter signal generator 14 acts as a modulator, and outputs analog modulated signals (in Data Mode) to the transmitter 20. The modulation can be AM (amplitude modulation), FM (frequency modulation), or phase modulation. Examples include frequency shift keying (FSK), AFSK, BPSK, or a variation or combination of these. Alternately the emitted carrier can be unmodulated, which can be particularly useful during the Measurement Mode of the system.

The transmitter 20 is an electronic device that accepts as an input an electronic signal from the transmitter signal generator 14, and modulates the electronic signal onto a carrier and power amplifies the signal, and outputs the signal to the antenna 26 via a T/R isolator 24. The transmitter 20 also provides an output that is impedance matched with the input of the T/R isolator 24 or the antenna 26.

The role of the T/R isolator 24 is to allow both a transmitter 20 and a receiver amplifier 22 to interface to the same antenna 26 while preventing the high level signals of the transmitter 20 to interfere with the operation of the receiver amplifier 22 or even cause damage to the receiver amplifier 22. That is, the T/R isolator 24 is the key component that allows for the use of a single radio channel to be used for two-way communications, particularly in a time-division multiplexing arrangement in which the antenna 26 is being used as a receiving antenna in one time slot, and as a transmitting antenna in a subsequent time slot. The T/R isolator 24 can include a switch, such as a low-resistance single-pole double-throw analog switch, which connects the antenna 26 to either the transmitter 20 or the receiver amplifier 22, but not both at the same time. Alternately, the T/R isolator 24 can include a filtering circuit that provides a low impedance connection of the antenna 26 to both the transmitter 20 and the receiving amplifier 22, which is readily accomplished if the transmitting carrier frequency is different than the received carrier frequency. In another configuration the T/R isolator 24 can be dispensed with and both the transmitter 20 and the receiving amplifier 22 can be directly connected to the antenna 26 provided that receiving amplifier 22 can withstand (and not detune) the RF power output by the transmitter 20, and can quickly react to incoming signals shortly after the transmitter 20 stops transmitting. Note also that the T/R isolator 24 can be eliminated if two antennas are used—one connected directly to the output of the transmitter 20 and the second connected to the input of the receiving amplifier 22.

The antenna 26 is typically a small monopole antenna that is used to convert the output of the transmitter into an electromagnetic energy emission 70. It is also used to convert received electromagnetic radio energy 72 into electrical energy suitable for amplification by the receiving amplifier 22. Nearly any electrical structure that resonates at the carrier frequency will suffice as the antenna 26. Typical antenna configurations include a) the wire dipole, which is a simple wire attached at one end to an output of the T/R isolator 24, b) PIFA, which stands for Printed Inverted F Antenna, which is a monopole antenna printed onto a PCB, c) the helix, which is similar to the wire monopole, except that it is coiled around a central core thereby making the dimensions smaller, and d) ceramic surface mount which are the smallest antennae, and are printed on high-dielectric constant slabs which concentrates the electric field. As a general rule, smaller antennae are preferred over larger antennae as smaller antennae have reduced uncertainty of the swipe profile measurement.

The receiving amplifier 22 accepts as input received signals from the antenna 26 by way of the T/R isolator 24, and amplifies and filters the signal before outputting the signal to the demodulator 18. The filter characteristics of the receiving amplifier are such that a band of frequencies are passed (and amplified) while all other are substantially blocked. The center frequency of the passband is nominally located at the carrier frequency that is being received, and the passband is broad enough to allow signals associated with the modulation method to pass as well. As an example, the center frequency for Bluetooth radio is typically 2.45 GHz, and the bandwidth is 100 MHz. Furthermore, the filtering characteristics can be changed as needed under the control of the digital processor 12 as different signals are being received. For example, the bandwidth of the filter of the receiving amplifier 22 may be wider in Sync Mode and Data Mode than in Measurement Mode.

The demodulator 18 accepts as input the amplified and filtered signal output to it by the receiving amplifier 22, and outputs a demodulated signal to an input of the digital processor 12. Also input to the demodulator 18 is a signal from an output of the timing generator 16 that serves as a local oscillator to aid in the demodulation. The demodulation process, in Measurement Mode, includes signal multiplication (or heterodyning), sampling, and digitization, although other subprocesses can be added or removed as needed or in other configurations. The demodulation process in Data Mode is significantly different, and the demodulation of the FSK (frequency shift keying), AFSK, PSK (Phase Shift Keying) or other forms of data modulation is carried out in ways commonly known to those skilled in the art.

The processing device 12 is coupled to and controls the operations of the transmitter signal generator 14 and the demodulator 18, although other types and numbers of processing systems coupled to other types and numbers of systems could be used. The processing device 12 includes a processing unit and a memory along with an operator input interface 30 and a display 32, although the processing device 12 can have other numbers and types of devices and components and the devices components can be in other locations and configurations. The memory stores programmed instructions and data for generating one or more secret keys as described and illustrated herein, including: converting obtained measurement data, such as the sampled data output by the demodulator 18 with respect to time, into one or more parameters, such as a change in phase, or phase velocity, or a change in phase velocity (phase acceleration), determine if a sufficient amount of the data has been obtained for averaging; determining if the obtained data is less than a data threshold for generating one or more keys; averaging one or more portions of the obtained data; converting the obtained data into a plurality of binary numbers; selecting at least one bit from at least a portion of the binary numbers to generate one or more keys; identifying a presence of one of the devices with respect to another one of the devices; determining if there is adequate signal strength for the obtaining the data; and synchronizing the systems before each of the data acquisition systems obtains the data, although other types and numbers of instructions and data can be stored and executed and some or all of these instructions and data may be stored elsewhere. A variety of different types of memory storage devices, such as a random access memory (RAM), a read only memory (ROM), hard disk, CD ROM, or other computer readable medium which is read from and/or written to by a magnetic, optical, or other reading and/or writing system coupled to the processing unit, can be used for the memory. Furthermore, at least portions of each of the devices of the exemplary embodiments may be conveniently implemented using one or more general purpose computer systems, microprocessors, digital signal processors, micro-controllers, FPGAs (Field Programmable Gate Arrays), CPLDs (Complex Programmable Logic Devices), ASICs (Application Specific Integrated Circuit), and the like, programmed according to the teachings of the exemplary embodiments, as described and illustrated herein, and as will be appreciated by those skilled in the computer and software arts.

Although an exemplary fixed position device 10 and a non-fixed position device 40(1) are described and illustrated herein, at least portions of these devices, such as processing computing devices 12 and 42, can be implemented on any suitable computer system or computing device, programmable logic device, application specific integrated circuit, FPGA, and the like. It is to be understood that the devices and systems of the embodiments described herein are for exemplary purposes, as many variations of the specific components, hardware and software used to implement the exemplary embodiments are possible, as will be appreciated by those skilled in the relevant art(s).

Although examples of the processing computing devices 12 and 42 are described herein, each of these devices can be implemented on any suitable computer system or computing device. It is to be understood that the devices and systems of the examples described herein are for exemplary purposes, as many variations of the specific hardware and software used to implement the examples are possible, as will be appreciated by those skilled in the relevant art(s).

Furthermore, these devices may be conveniently implemented using one or more general purpose computer systems, microprocessors, digital signal processors, and micro-controllers, programmed according to the teachings of the examples, as described and illustrated herein, and as will be appreciated by those ordinary skill in the art.

In addition, two or more computing systems or devices can be substituted for these devices. Accordingly, principles and advantages of distributed processing, such as redundancy and replication also can be implemented, as desired, to increase the robustness and performance of the devices and systems of the examples. The examples may also be implemented on computer system or systems that extend across any suitable network using any suitable interface mechanisms and communications technologies, including by way of example only telecommunications in any suitable form (e.g., voice and modem), wireless communications media, wireless communications networks, cellular communications networks, 3 G communications networks, Public Switched Telephone Network (PSTNs), Packet Data Networks (PDNs), the Internet, intranets, and combinations thereof.

Further, the examples may also be embodied as a non-transitory computer readable medium having programmed instructions stored thereon for one or more aspects of the present technology as described and illustrated by way of the examples herein, which when executed by a processor, cause the processor to carry out the steps necessary to implement these one or more aspects.

The operator input interface 30 is used to input data, such as information to complete a transaction, although other types of data could be input. The operator input interface 30 can be a keyboard, although other types and numbers of operator input interfaces can be used such as a keypad, a stylus or touchpad (used in conjunction with a surface acoustic wave display), a mouse or a trackball.

The display 32 is used to show data and information to the user, such as a transaction status and result, although other types of data and information could be displayed and other manners of providing the information can be used. The display 32 comprises a display screen, such as an LCD or OLED screen by way of example only, although other types and numbers of displays could be used. In this particular embodiment, the operator input interface 30 and display 32 are shown separate from the processing device 12, although other configurations can be used, such as having the operator input interface 30 and display 32 as part of the processing device 12.

The housing 28 may be diminutive in size, and encompass just those components associated with the radio hardware. At the other extreme the housing 28 may contain other components of the fixed device, such as power, interface, or magnetic strip reader electronic circuitry, in which case a larger and more substantial housing associated with a POS terminal proper is required. But in general the housing 28 just encloses the electronic circuitry associated with the present invention.

The non-fixed position or mobile device 40(1) can be a cell phone, although other types and numbers of devices could be used, such as a mobile handset, personal digital assistant (PDA), wireless headset, or other portable electronic device, and the devices could have a fixed position. The mobile device can also be a memory device, MP3 player, cell-phone, PDA, pager, key fob, camera, camcorder, laptop computer, or any other portable electronic device. The mobile device 40(1) also need not be small in size, and can be a vehicle such as a car or truck, boat, train, aircraft, spaceship, or a satellite, or contained within one of these vehicles.

The circuits, functional blocks, and subsystems of the mobile device 40(1) are substantially the same as those for the fixed device 10, as it pertains to the present invention, and a description of the circuits, functional blocks, and subsystems of the mobile device 40(1), with the exception of the housing 58, will be redundant and not be included here.

The housing 58 associated with the mobile device 40(1) is generally one and the same as the housing that encloses and packages the entire mobile device, including all other functions and devices that are typically found on the mobile device. For example, if the housing 58 is that of a mobile phone, the housing 58 may also enclose a cell-camera and the hardware associated with an IR data link.

The operation of the present invention at the functional block level is dependent upon the mode that the devices are in. There are three distinct modes of operation, Sync Mode, Data Mode, and Measurement Mode, and they will be described in detail below with reference to FIG. 1.

### Sync Mode

Sync Mode, or Synchronization Mode, occurs at the start of a swipe, and has three purposes. Firstly, at the start of Sync Mode the two devices 10 and 40(1) simply recognize that an opposing device is present. Secondly synchronization signals are sent between the devices 10 and 40(1) so that only one of the two devices 10 and 40(1) is transmitting a signal at any one time. Thirdly, handshaking signals are sent between the devices 10 and 40(1), in which non-sensitive data specific to the pending transaction is communicated. However, at no time is key material sent between the devices as part of the process of securing the communication channel.

The operation of each of the functional components of a communicating device 10 or 40(1) during Sync Mode will now be described with reference to FIG. 1 while the device is transmitting signals in Sync Mode.

While the device 10 is transmitting in Sync Mode, the digital processor 12 is responsible for determining what synchronization or handshaking characters or signals are to be sent to the mobile device 40(1) via the transmitter signal generator 14, etc., and the timing of the signal transmissions through the timing generator 16. The information that is being transmitted can be related to link management, such as probing signals or handshaking characters.

While the device 10 is transmitting synchronization or handshaking signals, the transmitter signal generator 14 receives the digital signals or characters from the digital processor 12 in a stream, or one at a time. This process of character communication from the digital processor 12 to the transmitter signal generator can be asynchronous with the timing of the communication between the devices 10 and 40(1), or it can be synchronous, as well as in a serial or parallel format. In either case, the transmitter signal generator 14 must accept, store, and buffer the synchronization or handshaking signals or characters from the digital processor 12 under control of the timing signals input to the transmitter signal generator 14 from the timing generator 16. As the signals or characters are to be output from the transmitter signal generator 14, again under the control of the timing generator 16, the transmitter signal generator 14 must serially output the data characters to the radio transmitter 20 at a frequency, modulation, voltage and impedance level suitable for use by the radio transmitter 20. That is, the transmitter signal generator 14 acts as a radio exciter, and modulates the signals or characters onto an RF carrier, and it is this modulated RF signal that is output from the transmitter signal generator 14 and input by the transmitter 20 during data or character transmission.

During Sync Mode the transmitter 20 simply accepts the low-level modulated signal input to it by the transmitter signal generator 14, and amplifies it to a power level suitable for over-the-air broadcasting. That is, the output from the transmitter 20 during the process of Sync Mode signal and character transmission is a high-level power-amplified RF signal that retains the waveform of the characters modulated onto it by the transmitter signal generator 14. Typically the output power can be from 10 mW to hundreds of Watts, or even more depending upon the width of the swipe gap 62. This output signal is then directed to an input of the T/R isolator 24.

During Sync Mode the T/R isolator 24 performs the same function in largely the same way is it does when used in Data Mode and Measurement Mode. That is, the T/R isolator 24 accepts the modulated RF signal from the transmitter 20, and passes it through to the antenna 26 with minimal losses, while at the same time minimizing the amount of modulated RF signal that is sent to the input of the receiving amplifier 22. However, the operating characteristics, such as bandwidth, of the T/R isolator 24 may be different in Sync Mode than in Data Mode or Measurement Mode. Specifically, the bandwidth of the T/R isolator may be increased (under the control of the digital processor 12) during Sync Mode.

During transmission, the antenna 26 performs the same function in largely the same way is it does when used in non Sync Mode transmission. That is, the antenna 26 accepts the modulated RF signal from the T/R isolator 24 and radiates the signal into the air with minimal losses.

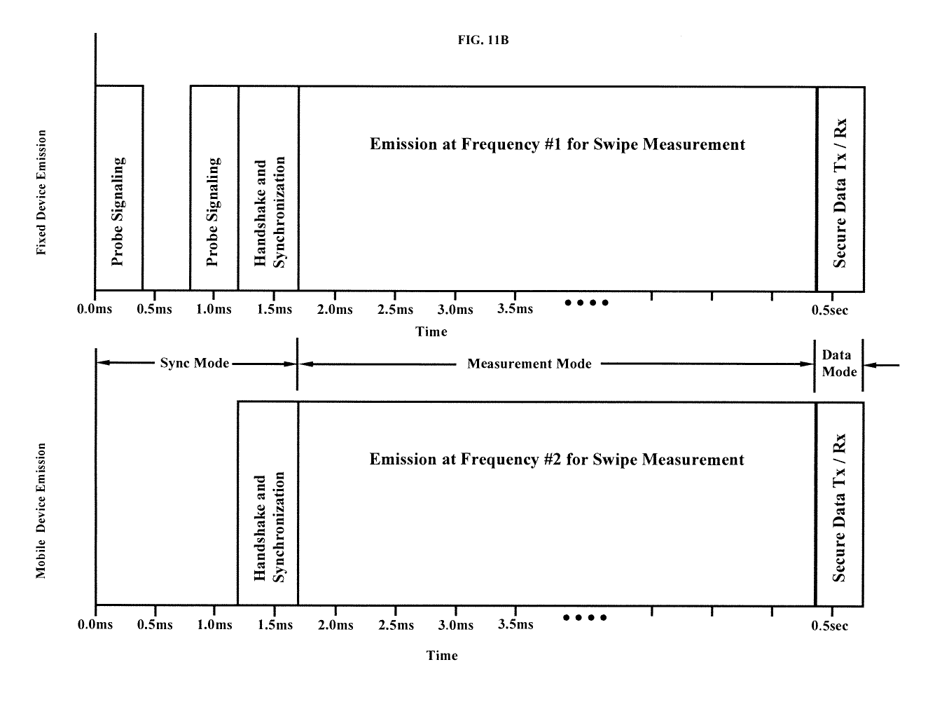

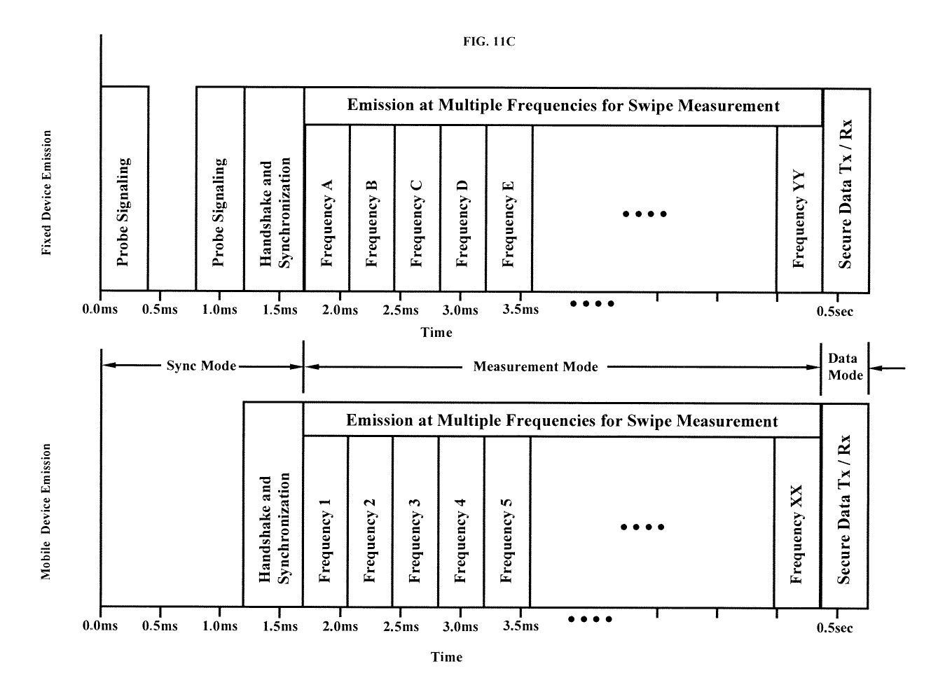

During transmission of Sync Mode signals and characters the receiving amplifier 22 and the demodulator 18 are nominally unused and inactive. However, if need be, they could be activated and used to monitor the emitted RF signal output by transmitter 20 by way of the T/R isolator 24. Alternately they could be used to receive Sync Mode signals sent by a mobile device 40(1) that is transmitted at a different frequency than is being transmitted by the fixed device 10. This is described in greater detail in connection with FIGS. 11B and 11C, below.

The input interface 30 is not used during Sync Mode per se, but is used by the user to initiate a transaction between the devices 10 and 40(1) in which Sync Mode is used. Once the transaction, consisting of Sync Mode, Measurement Mode, and Data Mode, is underway, no input from the user at the user interface 30 is usually required.

During the transaction between the devices 10 and 40(1) in which Sync Mode is used, the display 32 may indicate to the user that the transaction is underway. The display 32 will generally not need to display the specific operations of the transaction, e.g., whether the units are in Sync Mode, Data Mode, or Measurement Mode, and as such will generally not display to the user anything different while in Sync Mode as opposed to what is displayed during Measurement Mode or Data Mode. However, at the end of the transaction, the display may indicate to the user whether the transaction was successful or unsuccessful, and may prompt for future actions.

The operation of each of the functional components of a communicating device 10 or 40(1) during Sync Mode will now be described with reference to FIG. 1 while the device is receiving signals.

During reception of synchronization or handshaking signals transmitted by the mobile device 40(1) at the fixed device 10, the antenna 26 at the fixed device 10 receives the RF signal 72 transmitted by mobile antenna 56. The receiving antenna 26 performs substantially the same way regardless of whether the fixed device 10 is in Sync Mode, Data Mode, or Measurement Mode, in that it simply converts the RF signal 72 into an electrical current. The operation is the same regardless of whether the RF signal is modulated with data as is the case in Data Mode and Sync Mode, or is nominally unmodulated as is the case in Sync Mode and Measurement Mode (Sync Mode transmissions can be either modulated or unmodulated), as long as the underlying characteristics of the RF signal, such as its frequency, are approximately the same for both. In each case the received RF signal 72 is converted to an electrical signal which is then routed to the receiving amplifier 22 by way of the T/R isolator 24.

The T/R isolator 24 also operates the same way regardless of whether the receiving device, the fixed device 10 in this case, is in Sync Mode, Data Mode, or Measurement Mode. In all cases the signal passed to it from the antenna 26 is directed to the receiving amplifier 22 with little or no received electronic signal passed to the transmitter 20. This occurs as long as the bandwidth and frequency of the received electronic signal are approximately the same for Sync Mode, Data Mode, and Measurement Mode.

During reception of synchronization or handshaking signals while in Sync Mode, the gain and bandwidth of the receiving amplifier 22 should be matched to the signal strength and bandwidth of the electronic signal input to it by the T/R isolator 24. Generally the bandwidth of the electronic signal is wider when in Sync Mode, and under control of the digital processor 12 the bandwidth of the filter within the receiving amplifier 22 will be increased to match the signal's bandwidth. Note that the bandwidth should be no wider than is necessary so that as much noise as possible is removed from the signal.

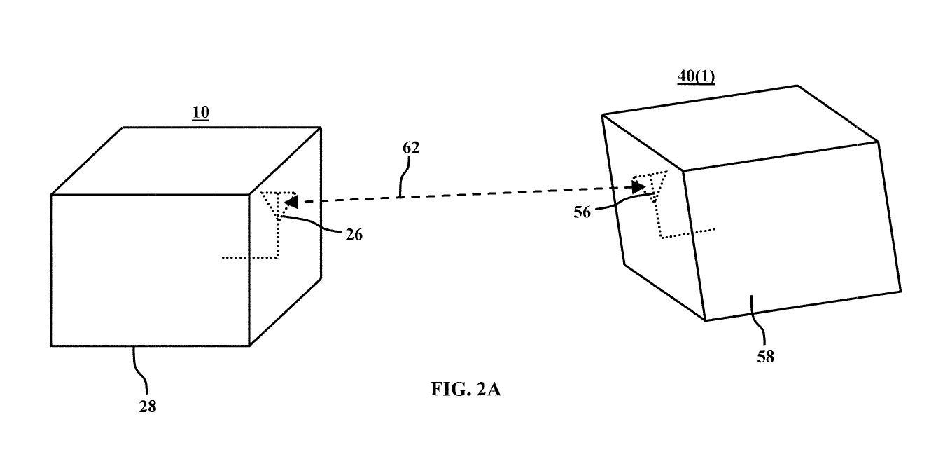

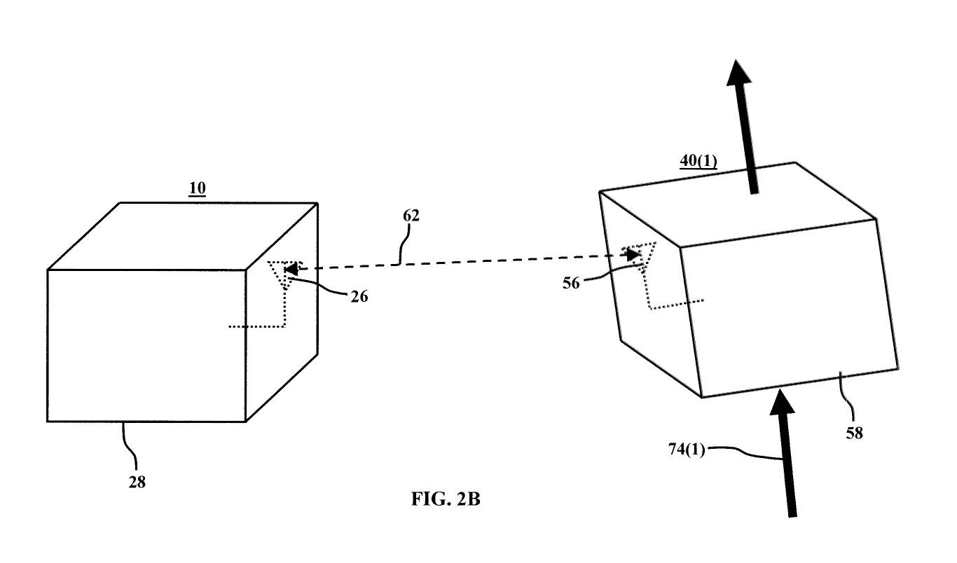

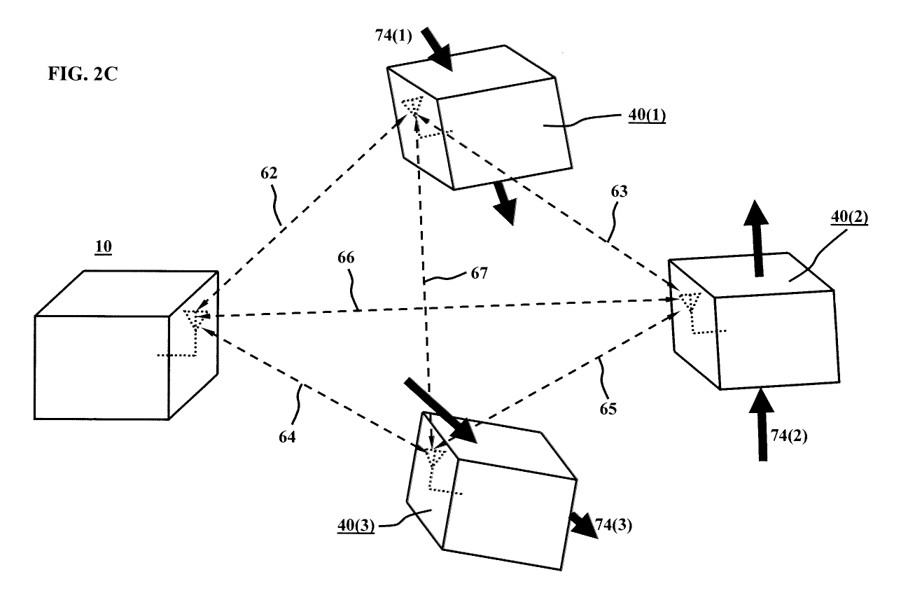

The demodulator 18 performs differently while operating in Sync Mode than in Data Mode or Measurement Mode while the fixed device 10 is receiving because some signals received during Sync Mode may be modulated characters whereas other received signals may be unmodulated. While in Sync Mode, the RF signal which is input to the demodulator 18, which may carry modulated handshaking characters, is demodulated by the demodulator 18. That is, the demodulator 18 removes any handshaking character(s) from the carrier of the RF signal input to it by the receiving amplifier 22. The character data is then converted to a digital format (the digitization may also occur within the digital processor 12) and the characters are stored or buffered within the demodulator 18 before being sent to the digital processor 12. Note that the demodulation process, described in detail below in connection with FIG. 2, also requires signals from the timing generator 16. Note that if unmodulated signals, such as synchronization signals, are input to the demodulator 18, the output of the demodulator 18 will not be a demodulated signal but instead will simply be another signal denoting that a carrier signal was received. This “carrier detect” signal is then routed to the digital processor 12 and is used to facilitate the handshaking and synchronization process.

The timing generator 16 performs a very important function while the fixed device 10 is receiving in Sync Mode in that it provides signaling to the demodulator 18 that is used by the demodulator 18 to remove the handshaking characters from the received RF signal. The timing generator 16 includes an oscillator or other frequency generation circuits that can act as a local oscillator for heterodyning the received signal as part of the demodulation process. Other circuits within the timing generator 16 are digital, and are responsible for coordinating the emissions and reception time slots between the two communicating devices 10 and 40(1) during the synchronization process.

While receiving in Sync Mode, the digital processor 12 controls the communication link management process and, in conjunction with the timing generator 16, synchronizes the timing between transmission and reception time slots. More importantly, it also collects the received handshaking characters input to it by the demodulator 18, and stores them as necessary.

While receiving in Sync Mode, the transmitter signal generator 14 and the transmitter 20 are nominally deactivated and do not perform any functions. Powering them down, under the control of the digital processor 12, is a means to conserve electrical power (especially in a battery-powered mobile device 40(1)) and reduce unwanted electrical noise. Alternately they could be used to transmit handshaking data and synchronization signals to a mobile device 40(1) wherein the transmission frequency of the fixed device 10 is different that that being transmitted by a mobile device 40(1). This is described in greater detail in connection with FIGS. 11B and 11C, below.

The input interface 30 is not normally used during Sync Mode reception per se, but may be used by the user to initiate a transaction between the devices 10 and 40(1) in which Sync Mode is used. Once the transaction, consisting of Sync Mode, Measurement Mode, and Data Mode, is underway, no input from the user at the user interface 30 is usually required.

### Data Mode

In Data Mode, data is being sent from one communicating device to the other. The data being sent is the encrypted transaction data, although the data could also be characters that provide a secure integrity check that ensures messages have not been modified during transmission, or characters to demonstrate proof of identity (authentication). The data is typically modulated onto the radio frequency carrier that is being transmitted by one device to the other. This carrier, as well as the measurement signal transmitted during Measurement Mode, can be of a frequency used in the Bluetooth communication standard which is in the ISM (Industrial, Scientific, Medical) band, or the frequencies can be those associated with IEEE standards 802.11 (LAN), 802.15 (PAN), 802.16 (Broadband), 802.20 (MBWA), or P1451.5 (Sensors), or those frequencies associated with GPS signaling. The modulation can be simple binary FSK (frequency shift keying) to minimize radio hardware complexity, or it can be DPSK (Differential Phase Shift Keying), including 8DPSK and DQPSK, for enhanced data rates.

The operation of each of the functional components of a communicating device 10 or 40(1) during Data Mode will now be described with reference to FIG. 1 while the device is transmitting data.

While the device 10 is transmitting data, the digital processor 12 is responsible for determining what data is to be sent to the mobile device 40(1) via the transmitter signal generator 14, etc., and the synchronization of the data transmission through the timing generator 16. The data that is being sent can be confidential or sensitive data that the user wishes to be kept secure during transmission. For the secure data, the digital processor encrypts the data with the use of the secret key bits that were determined, by the digital processor 12, after the swipe profile was characterized during Measurement Mode. The encrypted characters are then output by the digital processor 12 to the transmitter signal generator 14, etc., during the secure data transmission process.

While the device 10 is transmitting data, the transmitter signal generator 14 receives the data characters from the digital processor 12 in a stream, or one at a time. This process of character communication from the digital processor 12 to the transmitter signal generator 14 can be asynchronous with the timing of the communication between the devices 10 and 40(1), or it can be synchronous, as well as in a serial or parallel format. In either case, the transmitter signal generator 14 must accept, store, and buffer the data characters from the digital processor 12 under control of the timing signals input to the transmitter signal generator 14 from the timing generator 16. As the characters are to be output from the transmitter signal generator 14, again under the control of the timing generator 16, the transmitter signal generator 14 must serially output the data characters to the radio transmitter 20 at a frequency, modulation, voltage and impedance level suitable for use by the radio transmitter 20. That is, the transmitter signal generator 14 acts as a radio exciter, and modulates the data characters onto an RF carrier, and it is this modulated RF signal that is output from the transmitter signal generator 14 and input by the transmitter 20 during data transmission.

During data transmission the transmitter 20 simply accepts the low-level modulated signal input to it by the transmitter signal generator 14, and amplifies it to a power level suitable for over-the-air broadcasting. That is, the output from the transmitter 20 during the process of data transmission is a high-level power-amplified RF signal that retains the waveform of the characters modulated onto it by the transmitter signal generator 14. Typically the output power can be from 10 mW to hundreds of Watts, or even more depending upon the width of the swipe gap 62. This output signal is then directed to an input of the T/R isolator 24.

During data transmission the T/R isolator 24 performs the same function in largely the same way is it does when used in non data transmission mode. That is, the T/R isolator 24 accepts the modulated RF signal from the transmitter 20, and passes it through to the antenna 26 with minimal losses, while at the same time minimizing the amount of modulated RF signal that is sent to the input of the receiving amplifier 22. However, the operating characteristics, such as bandwidth, of the T/R isolator 24 may be different in Data Mode than in Measurement Mode. Specifically, the bandwidth of the T/R isolator may be increased (under the control of the digital processor 12) during Data Mode.

During transmission, the antenna 26 performs the same function in largely the same way is it does when used in non data transmission mode. That is, the antenna 26 accepts the modulated RF signal from the T/R isolator 24 and radiates the signal into the air with minimal losses.

During data transmission the receiving amplifier 22 and the demodulator 18 are nominally unused and inactive. However, if need be, they could be activated and used to monitor the modulated RF signal output by transmitter 20 by way of the T/R isolator 24. Alternately they could be used to receive data sent by a mobile device 40(1) that is transmitted at a different frequency than is being transmitted by the fixed device 10. This is described in greater detail in connection with FIGS. 11B and 11C, below.

The input interface 30 is not used during data transmission mode per se, but is used by the user to initiate a transaction between the devices 10 and 40(1) in which Data Mode is used. Once the transaction, consisting of Sync Mode, Measurement Mode, and Data Mode, is underway, no input from the user at the user interface 30 is usually required.

During the transaction between the devices 10 and 40(1) in which Data Mode is used, the display 32 may indicate to the user that the transaction is underway. The display 32 will generally not need to display the specific operations of the transaction, e.g., whether the units are in Sync Mode, Data Mode, or Measurement Mode, and as such will generally not display to the user anything different while in Data Mode as opposed to what is displayed during Measurement Mode. However, at the end of the transaction, the display may indicate to the user whether the transaction was successful or unsuccessful, and may prompt for future actions.

The operation of each of the functional components of a communicating device 10 or 40(1) during Data Mode will now be described with reference to FIG. 1 while the device is receiving data.

During reception of data transmitted by the mobile device 40(1) at the fixed device 10, the antenna 26 at the fixed device 10 receives the RF signal 72 transmitted by mobile antenna 56. The receiving antenna 26 performs the same way regardless of whether the fixed device 10 is in Data Mode or Measurement Mode, in that it simply converts the RF signal 72 into an electrical current. The operation is the same regardless of whether the RF signal is modulated with data as is the case in Data Mode, or is nominally unmodulated as is the case in Measurement Mode, as long as the underlying characteristics of the RF signal, such as its frequency, are approximately the same for both. In each case the received RF signal 72 is converted to an electrical signal which is then routed to the receiving amplifier 22 by way of the T/R isolator 24.

The T/R isolator 24 also operates the same way regardless of whether the receive device, the fixed device 10 in this case, is in Data Mode or Measurement Mode. In both cases the signal passed to it from the antenna 26 is directed to the receiving amplifier 22 with little or no received electronic signal passed to the transmitter 20. This occurs as long as the bandwidth and frequency of the received electronic signal are approximately the same for both Data Mode and Measurement Mode.

During reception of data while in Data Mode, the gain and bandwidth of the receiving amplifier 22 should be matched to the bandwidth and signal strength of the electronic signal input to it by the T/R isolator 24. Generally the bandwidth of the electronic signal is wider when in Data Mode, and under control of the digital processor 12, the bandwidth of the filter within the receiving amplifier 22 will be increased to match the signal's bandwidth. Note that the bandwidth should be no wider than is necessary so that as much of the noise as possible is removed from the signal.

The demodulator 18 performs a distinctly different operation in Data Mode than in Measurement Mode while the fixed device 10 is receiving. While in Data Mode, the RF signal which is input to the demodulator 18 which still carries the data modulated onto the signal is demodulated by the demodulator 18. That is, the demodulator 18 removes the data from the carrier of the RF signal input to it by the receiving amplifier 22. The data is then converted to a digital format (the digitization may also occur within the digital processor 12) and the characters are stored or buffered within the demodulator 18 before being sent to the digital processor 12. Note that the demodulation process also requires signals from the timing generator 16.

The timing generator 16 performs a very important function while the fixed device 10 is receiving in Data Mode in that it provides signaling to the demodulator 18 that is used by the demodulator 18 to remove the data from the received RF signal. The demodulator includes an oscillator or other frequency generation circuits that can act as a local oscillator for heterodyning the received signal as part of the demodulation process.

While receiving in Data Mode, the digital processor 12 collects the received data characters input to it by the demodulator 18, and stores them as necessary. If the received characters are encrypted, the digital processor decodes them by using the secret key bits generated during or near the end of the Measurement Mode process. Lastly, a decision is made by the digital processor 12 as to what characters may be written to the display 32, and this decision may be based upon the content of the received data.

While receiving in Data Mode, the transmitter signal generator 14 and the transmitter 20 are nominally deactivated and do not perform any functions. Powering them down, under the control of the digital processor 12, is a means to conserve electrical power (especially in a battery-powered mobile device 40(1)) and reduce unwanted electrical noise. Alternately they could be used to transmit data to a mobile device 40(1) wherein the transmission frequency of the fixed device 10 is different that that being transmitted by a mobile device 40(1). This is described in greater detail in connection with FIGS. 11B and 11C, below.

The input interface 30 is not normally used during data reception mode per se, but may be used by the user to initiate a transaction between the devices 10 and 40(1) in which Data Mode is used. Once the transaction, consisting of Sync Mode, Measurement Mode, and Data Mode, is underway, no input from the user at the user interface 30 is usually required.

Measurement Mode

During Measurement Mode the swipe profile of the time-varying gap between the devices is characterized by both devices concurrently. This characterization is accomplished by the devices each transmitting a signal to the other device, and during reception of the other device's transmitted signal the change in phase of the received signal is measured throughout the Measurement Mode portion of the swipe. The Measurement Mode portion of a swipe typically lasts about a half-second, although the Measurement Mode duration can last from less than one millisecond to more than several hours.

In Measurement Mode, a signal is sent from one communicating device to the other. The signal is nominally unmodulated, and no data is typically sent between the devices in Measurement Mode. Instead, in the simplest form, a carrier is simply transmitted from one device and then subsequently received at the other device. However, due to hardware limitations, in which there is normally only one antenna 26 available per device for transmission and reception of the signal, time division multiplexing is required, with the result that the transmitted signal is periodically stopped while a Measurement signal from the other device is momentarily received and processed. Indeed, the transmit-receive-transmit-receive cycle executes many many times during Measurement Mode, as will be described below in connection with FIG. 11A.

The operation of each of the functional components of a communicating device 10 or 40(1) during Measurement Mode will now be described with reference to FIG. 1 while the device is transmitting a measuring signal. The measuring signal can be an unmodulated carrier emission sent from one device to the other for the purpose of measuring the features—or change in features—of the gap between the devices as one device is moved with respect to the other. As a device moves, the phase of the received signal changes in accordance with the movement, and it is this phase change that is measured and processed to yield a series of secret key bits, although other characteristics of the received signal could be processed to yield the secret key bits as well.

When a device 10 is in Measurement Mode, the digital processor 12 (or possibly the timing circuitry incorporated into the timing generator 16) is responsible for coordinating the transmission of the signal with the activities of the other device 40(1), since it will also be in Measurement Mode, and it is undesirable to have both devices transmitting measurement signals of the substantially same carrier frequency at the same time. This coordination is accomplished with the aid of the timing generator 16 that provides timing signals to the digital processor 12 and transmitter signal generator 14, although other configurations that do not include the timing generator 16 are also possible. While in Measurement Mode, the digital processor 12 outputs a signal to the transmitter signal generator 14 that enables the transmitter signal generator 14 to create the unmodulated carrier signal.

When a device 10 is in Measurement Mode, the transmitter signal generator 14 generates the unmodulated carrier signal that is to be transmitted to the opposing device 40(1). This is accomplished while the transmitter 20 is enabled by the digital processor 12, using signals input to the transmitter signal generator 14 from an output of the timing generator 16. The RF measurement signal, being unmodulated and of limited bandwidth, is substantially sinusoidal, and has a frequency that minimally varies in accordance with the slight variations in the timing signals input to the transmitter signal generator 14 from the timing generator 16. The transmitter signal generator 14 may also have an internal filtering function to reduce noise, especially digital noise, and reduce the bandwidth of the generated RF measurement signal. The RF measurement signal is then output by the transmitter signal generator 14 to the transmitter 20.

While transmitting in Measurement Mode the transmitter 20 simply accepts the low-level unmodulated RF signal input to it by the transmitter signal generator 14, and amplifies it to a power level suitable for over-the-air broadcasting. That is, the output from the transmitter 20 during Measurement Mode transmission is a high-level power-amplified RF signal that retains the substantially sinusoidal waveform of the signal input to it by the transmitter signal generator 14. Typically the output power can be from 10 mW to hundreds of Watts, or even more depending upon the width of the swipe gap. This output signal is then directed to an input of the T/R isolator.

During Measurement Mode transmission the T/R isolator 24 performs the same function in largely the same way is it does when used in Data Mode. That is, the T/R isolator 24 accepts the RF signal from the transmitter 20, and passes it through to the antenna 26 with minimal losses, while at the same time minimizing the amount of RF signal that is sent to the input of the receiving amplifier 22. However, the operating characteristics of the T/R isolator 24 may be different in Measurement Mode than in Data Mode, such as its bandwidth. Specifically, the bandwidth of the T/R isolator 24 may be decreased (under the control of the digital processor 12) during Measurement Mode.

During Measurement Mode transmission the antenna 26 performs the same function in largely the same way is it does when transmitting in Data Mode. That is, the antenna 26 accepts the RF signal from the T/R isolator 24 and radiates the signal into the surrounding medium with minimal losses.

During Measurement Mode transmission, the timing generator 16 sources the RF signal that is used as the emission signal that is subsequently processed for measuring the characteristics of the swipe gap. This RF signal can be an analog or digital signal when it is output by the timing generator 16 and input at the transmitter signal generator 14, although if it is a binary signal it must be low-pass filtered before it is input to the transmitter 20.

During Measurement Mode transmission the receiving amplifier 22 and the demodulator 18 are nominally unused and inactive. However, if need be, they could be activated and used to monitor the RF signal output by transmitter 20 by way of the T/R isolator 24. Alternately they could be used to receive measurement signals sent by a mobile device 40(1) that is transmitted at a different frequency than the Measurement Mode signals being transmitted by the fixed device 10. This is described in greater detail in connection with FIGS. 11B and 11C, below.

The input interface 30 is not used during Measurement Mode signal transmission per se, but may be used by the user to initiate a transaction between the devices 10 and 40(1) in which the Measurement Mode is used. Once the transaction is underway, no input from the user at the user interface 30 is usually required.

During the transaction between the devices 10 and 40(1) in which Measurement Mode is used, the display 32 may indicate to the user that the transaction is underway. The display 32 will generally not need to display the specific operations of the transaction, e.g., whether the devices 10 or 40(1) are in Sync Mode, Data Mode, or Measurement Mode, and as such will generally not display to the user anything different to the user while in Data Mode as opposed to what is displayed during any other mode. However, at the end of the transaction, the display may indicate to the user whether the transaction was successful or unsuccessful, as well as prompts for future actions.

The operation of each of the functional components of a communicating device 10 or 40(1) during Measurement Mode will now be described with reference to FIG. 1 while the device is in a receiving configuration.

During reception of a measurement signal transmitted by the mobile device 40(1) at the fixed device 10, the antenna 26 at the fixed device 10 receives the unmodulated RF signal 72 transmitted by mobile antenna 56. The receiving antenna 26 performs the same way regardless of whether the fixed device 10 is in Data Mode or Measurement Mode, in that it simply converts the RF signal 72 into an electrical current. The operation is the same regardless of whether the RF signal is modulated with data as is the case in Data Mode, or is nominally unmodulated as is the case in Measurement Mode, as long as the underlying characteristics of the RF signal, such as its frequency, are approximately the same for both. In each case the received RF signal 72 is converted to an electrical signal which is then routed to the receiving amplifier 22 by way of the T/R isolator 24.

The T/R isolator 24 also operates the same way regardless of whether the receive device, the fixed device 10 in this case, is in Data Mode, Sync Mode, or Measurement Mode. In all cases the signal passed to it from the antenna 26 is directed to the receiving amplifier 22 with little or no received electronic signal passed to the transmitter 20. This occurs as long as the bandwidth and frequency of the received electronic signal is the same for both Data Mode and Measurement Mode.

During reception of a signal while in Measurement Mode, the gain and bandwidth of the receiving amplifier 22 should be matched to the bandwidth and signal strength of the electronic signal input to it by the T/R isolator 24. Generally the bandwidth of the electronic signal is narrower when in Measurement Mode, and under control of the digital processor 12, the bandwidth of the filter within the receiving amplifier 22 can be decreased to match the signal's bandwidth. Note that the bandwidth should be no wider than is necessary so that as much of the noise as possible is removed from the signal.

The demodulator 18 performs a distinctly different operation in Measurement Mode than in Data Mode while the fixed device 10 is receiving. While in Measurement Mode, the RF signal which is input to the demodulator 18 is heterodyned within the demodulator 18 and converted to a much lower frequency. That is, within the demodulator 18, the received RF measurement signal is multiplied by a local oscillator signal supplied by the timing generator 16, and the resulting signal is low pass filtered so that it becomes substantially sinusoidal and free of high-frequency components. This low-frequency signal is then sampled and converted to a digital format (the digitization may also occur within the digital processor 12) and the samples are stored or buffered within the demodulator 18 before being sent to the digital processor 12. Note that the signals that control the sampling rate also originate within the timing generator 16.

While the device 10 is receiving an RF measurement signal in Measurement Mode, the timing generator 16 provides signaling to the demodulator 18 that is used by the demodulator 18 to heterodyne the received measurement signal to a non-RF baseband signal. This signal is then sampled within the demodulator 18, and converted to a digital format with an A/D converter. The signaling that controls the timing of the A/D conversion process also originates within the timing generator 16.

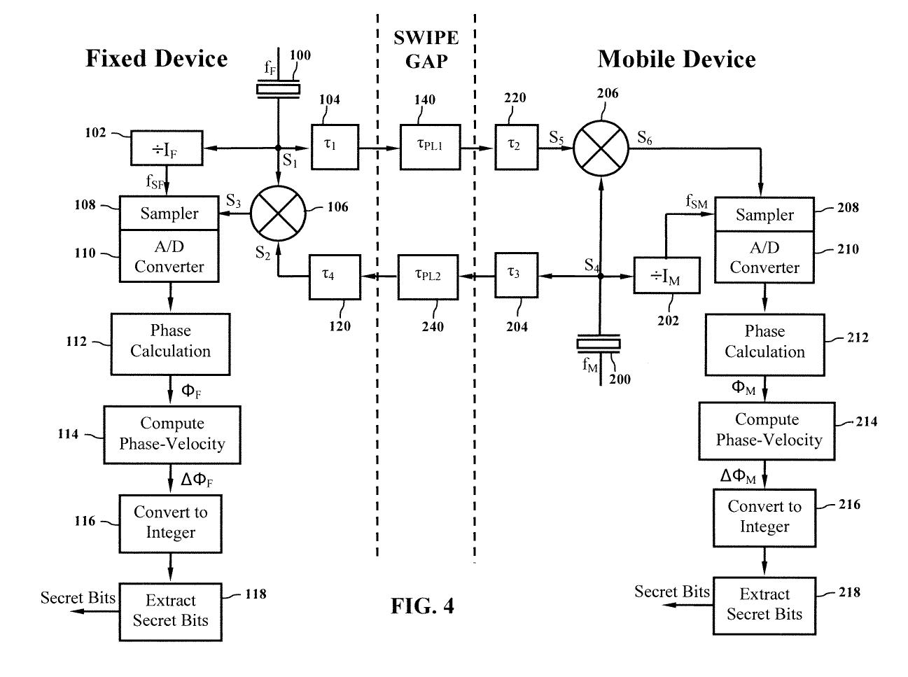

While receiving in Measurement Mode, the digital processor 12, in conjunction with the timing generator 16, controls the communication link management process and synchronizes the timing between transmission and reception time slots. The digital processor 12 also collects and processes the digitized samples of the baseband signal output by the demodulator 18. This processing, in which the secret key bits are generated based upon changes in the received signal, is described in greater detail in connection with FIG. 4, below. Lastly, after the secret key bits are generated, they are stored in memory for use in encrypting or decrypting the data characters which are subsequently sent between the devices 10 and 40(1) in Data Mode, or for providing a secure integrity check that ensures messages have not been modified during transmission, or to demonstrate proof of identity (authentication).

While receiving in Measurement Mode, the transmitter signal generator 14 and the transmitter 20 are nominally deactivated and do not perform any functions. Powering them down, under the control of the digital processor 12, is a means to conserve electrical power (especially in the battery-powered mobile device 40(1)) and reduce unwanted electrical noise. Alternately they could be used to transmit measurement signals to a mobile device 40(1) as long as it is being transmitted at a different frequency than is being transmitted by the mobile device 40(1). This is described in greater detail in connection with FIGS. 11B and 11C, below.

The input interface 30 is not normally used during Measurement Mode per se, but may be used by the user to initiate a transaction between the devices 10 and 40(1) in which Measurement Mode is used. Once the transaction is underway, no input from the user at the user interface 30 is normally required.

Note that the preceding description of the hardware described in connection with FIG. 1 assumed that just two communicating devices 10 and 40(1) were in use. However, it is possible that secure communications can be established at and between a third communicating device 40(2) as well. Indeed, communications among any number of devices, such as 1,000 (provided there is motion between them), can in principle be secured, in which a secure network will have been established. However, it is more likely that a small network consisting of just one fixed device 10, a mobile device 40(1), and a second mobile device 40(2) will be established. Nonetheless, a network comprised of M mobile devices 40(M), where M can be up to 1000 or more, is feasible.

Note also that the preceding description was focused on the subsystems associated with fixed device 10. However, the description of the subsystems of device 10 apply equally well to a description of the subsystems of mobile device 40(1), whose descriptions are not included here for brevity. Specifically, digital processor 42 performs substantially the same as digital processor 12, transmitter signal generator 44 performs substantially the same as transmitter signal generator 14, transmitter 50 performs substantially the same as transmitter 20, T/R isolator 54 performs substantially the same as T/R isolator 24, antenna 56 performs substantially the same as antenna 26, receiving amplifier 52 performs substantially the same as receiving amplifier 22, demodulator 48 performs substantially the same as demodulator 18, and timing generator 46 performs substantially the same as timing generator 16, for both receiving and transmitting modes of operation, as well as for Sync Mode, Data Mode, and Measurement Mode.

FIG. 2A shows the relative location in space of the fixed device 10 with respect to a position of the mobile device 40(1). Also shown are their respective antenna 26 and 56 which are separated by a distance 62. Since the mobile device 40(1) is readily and easily movable about the fixed device 10, the distance 62 is also easily and readily changed as well. One example of a movement of the mobile device 40(1) about the fixed device 10 is shown in FIG. 2B. In this diagram, mobile device 40(1) follows a path 74(1) as it is moved past the fixed device 10.

While the present invention has been described heretofore as being utilized for securing a channel between two communicating devices, it can also be applied to more than two. In FIG. 2C is shown an illustration in which there is one fixed device 10, and three mobile devices 40(1), 40(2), and 40(3). Note that the fixed device 10 is substantially motionless, while mobile devices 40(1), 40(2), and 40(3) have motion along direction arrows 74(1), 74(2), and 74(3) respectively. Note further that the path distance 62 between fixed device 10 and mobile device 40(1), the path distance 63 between mobile device 40(1) and mobile device 40(2), the path distance 64 between fixed device 10 and mobile device 40(3), the path distance 65 between mobile device 40(3) and mobile device 40(2), the path distance 66 between fixed device 10 and mobile device 40(2), and the path distance 67 between mobile device 40(1) and mobile device 40(3) are all varying in time in accordance with the motions of mobile devices 40(1), 40(2), 40(3). Note that a secret key will be generated for each pair of communicating devices linked by paths of distance 62, 63, 64, 65, 66, and 67. This arrangement of devices 10, 40(1), 40(2), and 40(3) can comprise a secure network over which data can be securely transmitted amongst any pair of devices of the network. Furthermore, while three mobile devices have been show, there can be many more than three, up to many thousand.

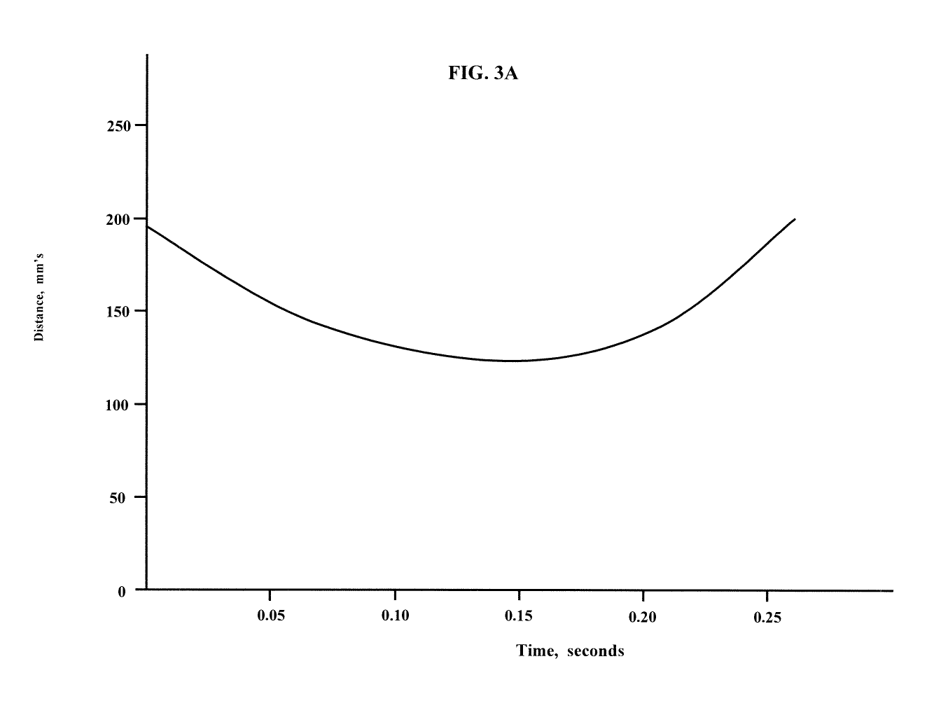

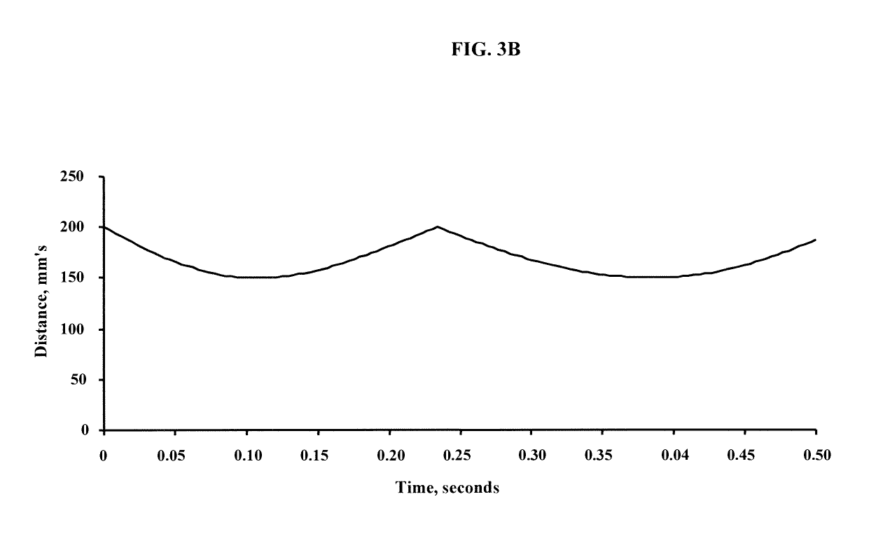

One example of the movement of the mobile device 40(1) about a fixed device 10 is in the form of a swipe, such that the distance 62 between the antennae 26 and 56 can trace out a path over time as shown in FIG. 3A. Alternately, a more complicated double-pass (i.e., back-and-forth) swipe movement of the mobile device 40(1) past the fixed device 10 is illustrated in FIG. 3B. Note that a substantially infinite number of movements, or swipes, of the mobile device 40(1) past the fixed device 10 are possible in the three-dimensional space about the fixed device 10. Furthermore, it is nearly impossible for a user to trace out two identical swipe movements or swipes of the mobile device 40(1) about the fixed device 10, no matter how hard one attempts to do so. It is this wide variety of non-repeatable movement of a mobile device 40(1) about a fixed device 10 that can serve as a source of entropy from which a series of secret key bits can be generated. Indeed, a secure data transaction between a fixed device 10 and a mobile device 40(1) can be made based upon the unique profile of a swipe motion.

Several variations can be made on the swipe or the motion of a mobile device 40(1) past a fixed device. For example, if the mobile device 40(1) is a satellite and the fixed device 10 is a ground station, then the swipe gap will be several hundred kilometers in length, and the swipe can occur over several minutes. Indeed, in extreme cases the duration of the swipe can be as little as 1 ms, or as great as one year. Furthermore the swipe can even be continuous, such that new secret key bits are continually being created. These additional new secret key bits can be used to augment pre-existing secret key bits (e.g., increasing the number of secret key bits from 1024 to 2048) to enhance security, or to replace earlier secret key bits whose values may have been compromised or whose desirable lifetime has been exceeded.

The swipe gap can be from 0.001 mm to 1000 Mm, or even longer. Furthermore the medium of the swipe gap or the medium surrounding or in between the fixed device 10 and a mobile device 40(1) can be air, vacuum, outer space, water (fresh or seawater), Earth, or any combination of these. If the distance 62 between the devices is appreciable, turbulence or other variations within the medium between the devices can be used as an additional source of entropy that is highly unique to the signal transmission path between the devices.

One way identical secret keys can be generated based upon a swiping motion, or any other kind of motion, of a mobile device 40(1) about a fixed device 10 will now be described. At the start of the key generation process, the user approaches the fixed devices 10 with the mobile device 40(1). The user may then authenticate himself or herself to the mobile device 40(1) by, for example, entering a PIN or otherwise presenting proprietary or biometric information to the mobile device 40(1) or the authentication process can be dispensed with.

Next the user swipes the mobile device 40(1) past the fixed device 10. At the start of the swipe, the devices 10 and 40(1) are in Sync Mode, and the mobile device 40(1) receives a probe signal from the fixed device 10 which is continually and periodically sent by the fixed device 10. The probe signal can be a special signal that is not modulated with data, or it can be a signal in which information is encoded onto the RF carrier. In either case, the probe signal is a unique signal that signifies to the mobile device 40(1) that it is near to a fixed device 10.

The mobile device 40(1) receives and decodes the probe signal, and determines that a fixed device 10 is nearby and ready to begin the key generation process. Next the two devices, that are still in Sync Mode, must synchronize and handshake, which is initiated by the mobile device 40(1) transmitting a special handshaking signal to the fixed device 10 in response to the received probe signal. The handshake signal can be a signal modulated with special digital data encoded to mean handshake, or it can be a unique signal not modulated with digital data. The details of the signal timing of the transaction is described below in connection with FIG. 11A-11C.

After the synchronization and handshaking of Sync Mode is complete, the fixed device 10 and the mobile device 40(1) enter Measurement Mode, in which unmodulated signals are transmitted and received by each other in a predetermined and synchronized manner. The fixed device 10 and the mobile device 40(1) then process their respective received signals to determine the changes in the received signals caused by the motion of a mobile device 40(1) about the fixed device 10. For example, the amplitude of the received signal at each of the fixed device 10 and the mobile device 40(1) will have changed in proportion to the distance 62 between them. If the antennae are isotropic radiators, then the signal amplitude will vary in accordance with the inverse-square law. Note that since the distance 62 between the antennae is the same for both devices 10 and 40(1) (indeed, there is only one distance 62 between the antennae, and it is common to both devices) then the amplitude variations will be common to both devices, and this common variation can be used as a source of common entropy from which the fixed device 10 and the mobile device 40(1) can generate common (i.e., identical) secret key bits.

Alternately, instead of using signal amplitude, changes in frequency of the signal received at each device can also be used. For example, as the mobile device 40(1) is moved past the fixed device 10, there will be a Doppler shift in the frequency of the measurement signal, and it will change in accordance with the radial velocity of the mobile device 40(1) as it moves past the fixed device 10. Since the radial velocity between the devices is common to both devices, the radial velocity can be used as a source of common entropy from which the fixed device 10 and the mobile device 40(1) can generate common (i.e. identical) secret key bits.

Alternately, instead of using signal amplitude or frequency changes, changes in the phase of the signal received at each device can be used. For example, as the mobile device 40(1) is moved past the fixed device 10, the distance 62 between the devices 10 and 40(1) will change, which causes the propagation delay time of the RF signals 70 and 72 to vary as well in accordance with the distance 62. As the signal propagation delay time changes, the phase of the received signal will vary in accordance with the signal propagation times (τ_{PL1} and τ_{PL2} of FIG. 4) and the distance 62. Again since the distance 62 between the devices is common to both devices, the distance 62 can be used as a source of common entropy from which the fixed device 10 and the mobile device 40(1) can generate common (i.e. identical) secret key bits based on shared phase changes of the received signals.

While received signal amplitude and received signal frequency changes can be used as the entropy source, the following describes in detail how the received signal phase changes can be measured, in Measurement Mode, at each device 10 and 40(1), and how the phase information can be used to generate a series of secret key bits that are identical at each device.

The processing functional blocks and signals that are used during Measurement Mode to generate the secret key bits will now be described with reference to FIG. 4. Note that the processing system of the fixed device 10 is substantially the same as the processing system of a mobile site 40(1), although they need not be, and processing configurations of the fixed device 10 can be significantly different than processing configurations of a mobile device 40(1).

An oscillator, such as a crystal oscillator 100, residing within the timing generator 16 of the fixed device 10, creates an RF measurement signal of frequency f_{F} at circuit location S₁. The signal S₁ is substantially sinusoidal (although it need not be), of unknown phase, but of a frequency that is known to within some tolerance. For example, f_{F} could be in the ISM band. More particularly f_{F} could be a frequency as specified in the Bluetooth standard (2.400 to 2.500 GHz), and have a tolerance of ±75 KHz.

The signal S₁ is routed to three different functional blocks. The first is to the transmission circuitry of the fixed device 10, consisting of transmitter signal generator 14, transmitter 20, T/R isolator 24, and antenna 26 as noted in FIG. 1. As shown in FIG. 4, the effects of these functions on the signal passing through them are to cause a signal propagation delay 104 of an amount τ₁. τ₁ is an unknown, albeit slowly varying, quantity that can be between one nanosecond and one millisecond in duration.

The signal S₁ is also routed to a multiplier 106 which multiplies two electronic signals together. In this case the multiplier acts as heterodyne functional block, in which the signal S₁ acting as a local oscillator is mixed with the received signal S₂. The output signal S₃ contains the sum and difference of the S₁ and S₂ although the sum terms are filtered out and not used. The multiplier 106 resides within the demodulator 18 as shown in FIG. 1.

The second signal input to the multiplier 106 is the signal S₂ output by the receiving amplifier 22. In terms of signal processing, the amplification of the receiving amplifier 22 on the received signal does not have a large impact on phase computation, and is largely transparent. However, the propagation delay τ₄ of the receiving amplifier 22 causes an unknown, but slowly varying phase shift of signal S₂, which needs to be accounted for while computing a phase measurement that is dependent only on the motion characteristics of a mobile device 40(1) relative to the fixed device 10.

The signal S₁ is also routed to a divider 102 functional block, that also resides within the timing generator 16 as shown in FIG. 1. The divider 102 simply divides the frequency of RF signal S₁ by an integer I_{F}, so that a lower frequency signal f_{SF} is generated. f_{SF} is of a frequency suitable for use as a sampling rate for collecting samples of the heterodyned output signal S₃.

The sampler 108 resides within the demodulator 18, and includes a low-pass filter for filtering out the sum frequency output by the multiplier 106, and a sample and hold circuit that is used to collect a near-instantaneous sample of a voltage of the signal S₃, and hold it constant while a downstream A/D conversion circuit 110 digitizes the held voltage. Typically the sampling function is accomplished with an electronic switch, and the sampled voltage is held constant on a capacitor during conversion. Depending on the type of the phase computation algorithm employed in the phase calculation 112 functional block, anywhere from just two samples per cycle of signal S₃ up to several thousand samples per cycle are needed. In the case where S₁ and S₂ have the same nominal center frequency, excepting the ±150 KHz differential tolerance, a sampling rate of from between 300,000 samples/second up to 300,000,000 samples/sec will be needed, although a typical sampling rate is about 5,000,000 samples per second as discussed later.

The A/D converter 110 resides within the demodulator 18 as well, although it can alternately reside within the digital processor 12. The A/D converter 110 simply converts the analog signal that was sampled and held by the sampler 108 into a digital format. Typically the digital value can be a 16-bit output, although outputs as low as 12-bits, or as high as 24-bits, can be used.

The output of the A/D converter 110 is stored in memory within the digital processor 12, where it is subsequently processed, along with other samples, to compute the phase of the signal S₃. The phase computation algorithm employed by the digital processor 12 can be a Fourier Transform, in particular a discrete Fourier Transform (DFT), or even a fast Fourier Transform (FFT). The phase computation algorithm employed within the digital processor 12 may also be based upon centroid calculations, in which the centers (or troughs) of each cycle of S₃ is computed. The phase computation algorithm employed within the digital processor 12 may also be based upon zero-crossing calculations, in which the mid-points of each cycle of S₃ are computed. The phase computation algorithm employed within the digital processor 12 may also be based upon a curve-fitting algorithm, especially one involving non-linear regression, and in particular the Gauss-Newton non-linear regression algorithm (which is a multidimensional variation on the Newton or Newton-Raphson root-finding methods), in which one or more cycles of the sampled signal S₃ is fit to a sinusoid. Alternately, two or more of these four algorithms may be employed to achieve the best phase estimation.

The output of the phase calculation process 112 is a table of floating point numbers, where the number of entries is substantially the same as the number of secret key bits that are to be generated plus one. The numbers in the table each represent a computed phase measurement during a particular time slot during the swipe of a mobile device 40(1) past the fixed device 10. For example, numbers at the start of the table may represent the computed phase at the start of a swipe. In general, however, the entries in the table output by the phase calculation 112 process will not match the entries in the table output by the phase calculation 212 process, owing to the unknown propagation time delays τ₁, τ₂, τ₃, and τ₄.

To generate tables of data that are identical at both devices 10 and 40(1), the offending time delay offsets are eliminated from the data by performing a subtraction process on the raw phase data in the Compute Phase-Velocity 114 process. The output of the Compute Phase Velocity 114 process is a table of floating point numbers that represent the time rate of change of the phase measurements, and are substantially the same, or at least proportional, at the devices 10 and 40(1).

The table of floating point Phase-Velocity (or Δ-Phase) data is then input to the Convert to Integer process 116, where the floating point numbers are scaled, if necessary, by multiplying the values by a constant value, so they occupy most bits of the integer word after they are converted to integer data type. The conversion from floating point to integer is straightforward, and is carried out in ways known to those skilled in the art.

After all of the Phase-Velocity data has been converted to an integer data type, one or more columns of bits are selected to form the series of secret key bits by the extract secret key bits 118 process.

The processes described above can be implemented in electronic circuitry comprised of individual integrated circuits, such as an integrated circuit for the digital processing processes consisting of the phase calculation 112, the compute Phase-Velocity 114, the convert to integer 116, and extract secret key bits 118. The A/D converter 110 can also be a standalone component, or it can be integrated into a digital processor 12 as well. The sampler 108 can be a circuit assembled from standalone electronic components, or it can be integrated into a component containing other processing functions or additional processing functions. Furthermore the multiplier 106 can be assembled from individual electronic components, or it can be integrated into a component containing other processing functions as well, as can the division 102 process block. Indeed, it is feasible for all of the processing functions described above to be integrated into one small integrated circuit package. The integration can be in the form of an ASIC (application specific IC), or an FPGA, or as a custom device, or a combination of these.

While not described in detail for brevity, the processing functions of the mobile device 40(1) are substantially the same as the processing functions of the fixed device 10 while in Measurement Mode. That is, the crystal oscillator 200 performs in the same way as crystal oscillator 100, although its output frequency f_{M} may be different than the frequency f_{F} produced by crystal oscillator 100. Furthermore the division 202 functional block performs in the same way as division 102 functional block, although the amount of division I_{M} of the division 202 functional block may be different than the amount of division I_{F} taking place within the division 102 functional block. The Sampler 208 process is substantially the same as Sampler 108. The A/D Converter 210 process is substantially the same as A/D Converter 110. The Phase Calculation process 212 is substantially the same as Phase Calculation process 112, although they need not be, and any one of the four phase computation methods (or others) can be employed at either device 10 and 40(1). The Compute Phase Velocity 214 process is substantially the same as Compute Phase Velocity 114 process. The Convert to Integer 216 process is substantially the same as Convert to Integer 116 process. Finally the Extract Secret Bits 218 process is substantially the same as Extract Secret Bits 118 process.

The following is a list of symbol definitions that will be used in subsequent paragraphs that describe in detail a mathematical algorithm for processing a received RF signal and generating a series of secret key bits:
f_{F}=Emission carrier frequency of the fixed device 10.
   Can be 2.400 GHz (±75 KHz), a Bluetooth frequency.
f_{M}=Emission carrier frequency of the mobile device 40(1).
   Can be 2.400 GHz (±75 KHz), a Bluetooth frequency.
f_{DF}=Doppler frequency shift of the carrier frequency emitted by the fixed device 10 as received at the mobile device 40(1).
f_{DM}=Doppler frequency shift of the carrier frequency emitted by the mobile device 40(1) as received at the fixed device 10.
τ₁=Signal propagation time through the transmitter of the fixed device 10. Assumed to be slowly varying (quasi-constant) in time.
τ₂=Signal propagation time through the receiver of the mobile device 40(1). Assumed to be slowly varying (quasi-constant) in time.
τ₃=Signal propagation time through the transmitter of the mobile device 40(1). Assumed to be slowly varying (quasi-constant) in time.
τ₄=Signal propagation time through the receiver of the fixed device 10.

Assumed to be slowly varying (quasi-constant) in time.
τ_{PL1}=Signal propagation time of the signal transmitted by the fixed device 10 through the swipe gap to a mobile device 40(1). τ_{PL1} is variable, and varies in time in accordance with the width of the swipe gap 62.
τ_{PL2}=Signal propagation time of the signal transmitted by a mobile device 40(1) through the swipe gap to a fixed device 10. τ_{PL2} is variable, and varies in time in accordance with the width of the swipe gap 62.
S₁=RF measurement signal generated by the oscillator 100 at the fixed device 10. S₁=A_{F} cos(2πf_{F}t+φ_{F})
S₄=RF measurement signal generated by the oscillator 200 at the mobile device 40(1). S₄=A_{M} cos(2πf_{M}t+φ_{M})
S₂=RF measurement signal received by the fixed device 10 at the output of the receiving amplifier 22.
   S₂=B_{F} cos(2πf_{M}t+2πf_{DM}t+2πf_{M}τ₃+2πf_{M}τ_{PL2}(t)+2πf_{M}τ₄+φ_{M})
S₅=RF measurement signal received by the mobile device 40(1) at the output of the receiving amplifier 52.
   S₅=B_{M} cos(2πf_{F}t+2πf_{DF}t+2πf_{F}τ₁+2πf_{F}τ_{PL1}(t)+2πf_{F}τ₂+φ_{F})
A_{FOS}=DC offset voltage of signal S₃ within the fixed device 10.
A_{MOS}=DC offset voltage of signal S₆ within the mobile device 40(1).
A_{M}=Amplitude of the signal S₄ within a mobile device 40(1).
B_{M}=Amplitude of the signal S₅ within a mobile device 40(1).
A_{F}=Amplitude of the signal S₁ within the fixed device 10.
B_{F}=Amplitude of the signal S₂ within the fixed device 10.
φ₆=The phase of the heterodyned signal at a mobile device 40(1).
φ₃=The phase of the heterodyned signal at the fixed device 10.

From the above list of variables, an analysis of the math behind the secret key generating algorithm can be presented. The signal processing begins with S₃ and S₆, as follows:

S₃=S₁×S₂ Equation 1

S₃=A_{FOS}+A_{F} cos(2πf_{F}t+φ_{F})×B_{F} cos(2πf_{M}t+2πf_{DM}t+2πf_{M}τ₃+2πf_{M}τ_{PL2}(t)+2πf_{M}τ₄+φ_{M}) Equation 2

S₃=A_{FOS}+½A_{F}B_{F} cos(2πf_{F}t+φ_{F}−2πf_{M}t−2f_{DM}t−2f_{M}τ₃−2πf_{M}τ_{PF2}(t)−2πf_{M}τ₄−φ_{M})+½A_{F}B_{F} cos(2πf_{F}t+φ_{F}+2πf_{M}t+2πf_{M}τ₃+2πf_{DM}t+2πf_{M}τ_{PL2}(t)+2πf_{M}τ₄+φ_{M}) Equation 3

The additive terms in Equation 3 are high frequency, and exceed the bandwidth of the electronics in the circuitry associated with the multipliers 106 and 206 and sampler 108 and 208, and are filtered out leaving only the low frequency difference terms:

S₃=A_{FOS}+½A_{F}B_{F} cos(2πf_{F}t+φ_{F}−2πf_{M}t−2πf_{DM}t−2πf_{M}τ₃−2πf_{M}τ_{PL2}(t)−2πf_{M}τ₄−φ_{M}) Equation 4

Similarly

S₆=A_{MOS}+½A_{M}B_{M} cos(2πf_{M}t+φ_{M}−2πf_{F}t−2πf_{DF}t−2πf_{F}τ₁−2πf_{F}τ_{PF1}(t)−2πf_{F}τ₂−φ_{F}) Equation 5

Let f_{F}−f_{M}=Δf. Also let 2πf_{M}τ₃+2πf_{M}τ₄=φ_{K}, and 2πf_{F}τ₁+2πf_{F}τ₂=φ_{L}. Furthermore, assume that τ_{PF2}(t)=τ_{PF1}(t)≡τ_{PL}(t) and is time-varying. In this case:

S₃=A_{FOS}+½A_{F}B_{F} cos(2πΔft−2πf_{DM}t−2f_{M}τ_{PL}(t)−φ_{K}+φ_{F}−φ_{M}) Equation 6

and

S₆=A_{MOS}+½A_{M}B_{M} cos(−2πΔft−2πf_{DF}t−2πf_{F}τ_{PL}(t)−φ_{L}−φ_{F}+φ_{M}) Equation 7

There are four different phase terms, Φ_{K}, Φ_{F}, Φ_{F}, and Φ_{M}, in Equations 6 and 7, whose values depend on the performance of the circuitry described in FIGS. 1 and 4. Ideally these four phase terms are constant and can be removed with a subtractive as described below. There are two other phase terms, 2πf_{M}τ_{PL}(t) and 2πf_{F}τ_{PL}(t), whose values change in accordance with the width of the swipe gap, and are therefore strong functions of time.

Equations for S₃ and S₆ are both of the form S=DC+P cos(2πft−Φ), where DC is the DC offset of the signal S, P is the amplitude of the signal, and Φ is the phase. All of the variables DC, P, f, and Φ are substantially unknown. It is desired to find Φ as precisely as possible, but a discussion of how to do that is deferred. For now it is safe to assume that the phase terms can be found numerically by processing Equations 6 and 7. Symbolically the phase terms are

φ₃=2πf_{M}τ_{PL}(t)+φ_{K}−φ_{F}+φ_{M} Equation 8

φ₆=2πf_{F}τ_{PL}(t)+φ_{L}+φ_{F}−φ_{M} Equation 9

The constant terms within Equations 8 and 9 can be removed with a subtractive process in which Phase Velocities (Δ-Phases) are computed by subtracting the phases from time-offset values of themselves.

Δφ₃=(2πf_{M}τ_{PL}(t)+φ_{K}−φ_{F}+φ_{M})−(2πf_{M}τ_{PL}(t+δ)+φ_{K}−φ_{F}+φ_{M}) Equation 10

Δφ₆=(2πf_{F}τ_{PL}(t)+φ_{L}+φ_{F}−φ_{M})−(2πf_{F}τ_{PL}(t+δ)+φ_{L}+φ_{F}−φ_{M}) Equation 11

Strictly speaking, as mentioned earlier the phase terms Φ_{K}, Φ_{L}, Φ_{F}, and Φ_{M} are not constant, but can slowly vary in time. If they were constant then their values would simply subtract out in Equations 10 and 11. However if we make the assumption that φ_{K}, Φ_{F}, Φ_{L}, and φ_{M} vary slowly and that their values are substantially constant during the time difference of interest, δ, then they can be safely subtracted out in Equations 10 and 11. An upper bound for δ would be one-quarter of the time it takes it takes to complete a swipe, or 125 ms. After the four quasi-constant phase terms Φ_{K}, Φ_{L}, Φ_{F}, and Φ_{M} are subtracted, Δφ₃ and Δφ₆ become:

Δφ₃=2πf_{M}[τ_{PL}(t)−τ_{PL}(t+δ)] Equation 12

Δφ₆=2πf_{F}[τ_{PL}(t)−τ_{PL}(t+δ)] Equation 13

Since f_{F}=f_{M} except for the tolerance of the frequency sources 100 and 200, then Δφ₃=Δφ₆. Note that if the Bluetooth frequency specification is used, the ±75 KHz tolerances on the 2.4 GHz frequencies are ‘in the noise’ and do not have an appreciable affect on the final Δφ computation of Equations 12 and 13. In this way the same mathematical information about the swipe profile is available at both the fixed device 10 and the mobile device 40(1) in the form of the Phase Velocities Δφ₃ and Δφ₆. As mentioned before, the Phase Velocity is a series of discrete real-valued numbers, where the number of values in the series is equal to the number of secret bits that are desired. At this point it is a simple matter to convert the real-valued AO numbers to an integer data-type, and then extract one or more columns of bits from the integers to use as the secret bits.

The range of the carrier frequency, f_{M} or f_{F}, can be such that their wavelength is between 10 km and 0.1 μm. f_{M} or f_{F} can be substantially equal (difference less than 150 KHz), or unequal (difference greater than 150 KHz, up to 10 GHz). Optical frequencies can also be used as the emission signal, and the heterodyning can occur optically as well.

Note, however that the difference between the frequencies of S₃ and S₆ need to be greater than a certain threshold for there to be a minimum number of cycles on which to measure the phase with. At the extreme case where the frequencies input to the multiplier 106 or 206 are the same, S₃ and S₆ will have zero frequency, in which it is meaningless to attempt to compute a phase. As an example, if the sampling window is 0.5 ms, and if a minimum of two cycles are needed for phase estimation, then the difference in frequencies of the two signals input will need to be at least 2/0.0005=4,000 Hz.

There is another key point about the relationship between the signals S₃ and S₆. Clearly for the purposes of the present invention the phase relationships (or more particularly the change in phase during a swipe) of the signals must be substantially the same. A more subtle point is that the frequencies of these two signals S₃ and S₆ must also be substantially the same, within some small tolerance. This means that it is generally not possible for there to be, for example, a local oscillator that runs independent of the main oscillators 100 and 200, as the frequency of the independent oscillator will always drift or vary in frequency, to some extent, with regard to a transmit or receive signal S₁, S₂, S₄, or S₅. Fortunately additional oscillators are not required, as the same two frequencies generated by both sources 100 and 200 are available at both devices simultaneously. That is, at the fixed device 10, the transmitter frequency of S₁ is the same as the received signal frequency S₅ at the mobile device 40(1), and at the mobile device 40(1), the transmitter frequency of S₄ is the same as the received signal frequency S₂ at the fixed device 10. Because of this, the frequencies of the signals S₃ and S₆ output from the multipliers 106 and 206 will always have the same magnitude. Note further that this is the case even as the frequencies of the oscillator signals S₁ and S₄ vary in time due to oscillator drift. Indeed, these variations in oscillator frequency, which are intrinsically and identically removed during the heterodyning and phase/frequency computation processes, can provide an additional layer of process integrity or entropy to guard against third party eavesdropping and key generation during the Measurement Mode process.

It is even possible to use Doppler-induced frequency variations of the received RF carrier as an alternate (or additional) source of entropy from which secret key bits can be generated. The Doppler shift is dependent on the radial velocity of one device past the other during the swipe according to the formula:

f_{D}=f_{C}sqrt[(c−v)/(c+v)] Equation 14

where f_{D} is the Doppler shift, in Hertz, f_{C} is the carrier frequency, c is the speed of light, and v is the radial velocity of the devices. If f_{C}=2.4 GHz and an upper limit of v is 4 meters/second, then an upper limit on f_{D} is 32 Hz. A good frequency-determining algorithm, such as one utilizing non-linear regression, can compute the frequency shift occurring over the course of a swipe, and use that information as data from which a series of secret key bits can be generated as discussed below.

A problem at this point is in determining the phase values of signals S₃ and S₆, which is complicated by the fact that the phases are changing in time in accordance with the swipe motion, and that the frequency of the underlying signal S₃ and S₆ can be from a few kilohertz to ±150 kHz or more.

One way to find the phase is by collecting four sample points over one cycle of signal, and then using those data points to solve a series of four simultaneous equations. For example, if S_{3,1}, S_{3,2}, S_{3,3}, and S_{3,4} are four samples of S₃, collected at known times t₁, t₂, t₃, and t₄, then these values can be plugged into the following set of simultaneous equations, from which the parameters DC, P, f, and Φ can be found.

S_{3,1}=DC+P cos(2πft₁−Φ) Equation 15

S_{3,2}=DC+P cos(2ft₂−Φ) Equation 16

S_{3,3}=DC+P cos(2ft₃−Φ) Equation 17

S_{3,4}=DC+P cos(2ft₄−Φ) Equation 18

Unfortunately the set of simultaneous equations, Equation 15 through Equation 18, can only be solved iteratively, as they are transcendental in nature. If one is forced to use an iterating algorithm for determining phase, it would be desirable to use an algorithm that is especially designed to iterate to a solution rapidly, and with a minimum of computational overhead.

One such class of iterating algorithms are the multi-variable nonlinear curve-fitting methods, also known as nonlinear regression, and more particularly the Gauss-Newton method of non-linear regression. The Gauss-Newton algorithm can be used to minimize a sum of squared function values, and has the advantage that second derivatives, which can be challenging to compute, are not required. First derivatives are required to estimate the slope of the curve between a present solution and the next best solution while iterating.

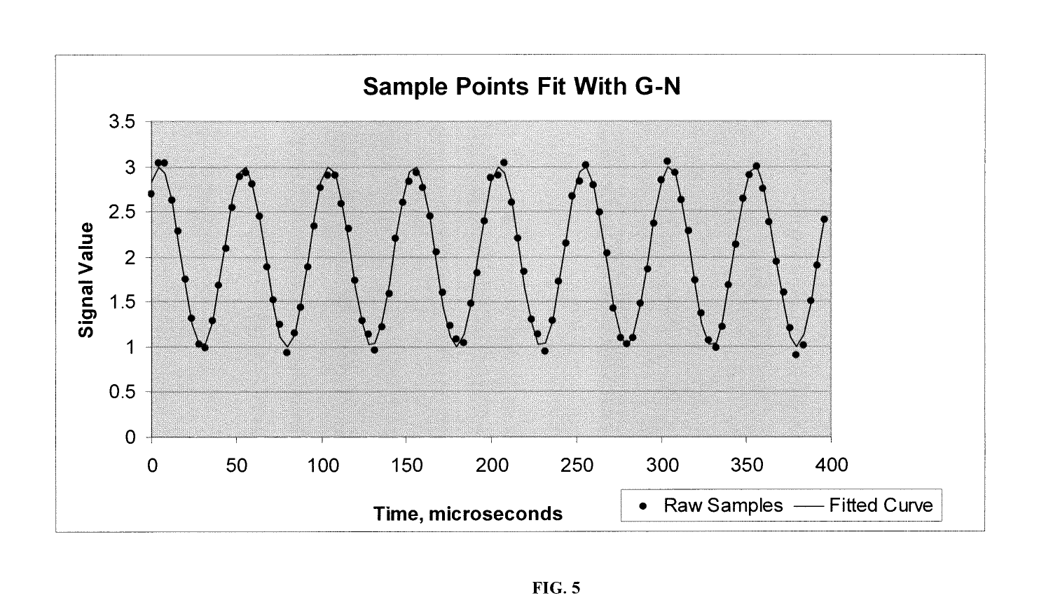

To implement the Gauss-Newton (G-N) algorithm, a series of samples are collected over a sampling window containing from one to several cycles of the unknown signal S₃ or S₆. Typically these samples have some amount of random noise in them, which makes the regression properties of the Gauss-Newton algorithm even more attractive as the resulting curve-fit will average over the noise, resulting in a good fit and good estimations of all of the parameters DC, P, f, and Φ. An example of the samples and a fitted curve is shown in FIG. 5. In this plot, 100 raw sample values were collected over 400 μs, and the SNR of the waveform is 50:1. The parameters of the sinusoid being fit in FIG. 5 are: DC=2.00, P=1.00, f=20 KHz, and Φ=0.6035 radians.

The sampling rate is 250,000 samples/second. In this case the G-N algorithm estimated the actual phase of the signal—in the presence of noise—to an error of less than 0.00013 radians. Note that the number of samples of the signal used for the nonlinear regression must be at least equal to the number of variables that are to be solved, although better fits can be made with more sample data points. An upper limit on the number of data samples is usually determined by the processing speed of the digital processor, but for most practical applications 1,000,000 sample points will take an inordinate amount of time to process with nonlinear regression, and represents a practical upper limit, although high-power super-computers can process even more samples in a short period of time.

The key to a successful execution of the Gauss-Newton algorithm is to obtain good initial estimates of the parameters DC, P, f, and Φ that need to be determined. If the initial estimates are poorly chosen, the Gauss-Newton algorithm may fail to converge, or may converge to the wrong answer. One way to estimate the DC term is by determining a priori the value of the signal that is present when the amplitude P of the signal is zero. One way to estimate the amplitude term P is by executing computer code that finds the greatest departure of the signal from the DC term, and using that as P. One way to estimate the frequency f is by executing computer code that finds the time between peaks (or equivalently troughs) of the sampled signal, which is the period of the signal. Yet another way is to estimate the zero crossings of the sinusoid, the Period being twice the time between zero crossings. An estimate of the frequency f is simply the reciprocal of the period. An estimate of the phase, at time zero, can be found by noting the initial slope of the sampled signal, and whether the initial value is above or below the DC level. By determining these data, the quadrant of the sampled signal at time zero can be determined, and the initial phase estimated to π/2.

One other additional benefit of the Gauss-Newton algorithm is that it can solve for negative variable terms. For example, it can be set up to solve for negative frequency “−f” instead of frequency, which can be of great utility when solving for the negative Δf term of Equations 7.

While the Gauss-Newton method can work extremely well and yield high precision phase estimates in presence of noise, it has three drawbacks: it can be computationally expensive (it relies on linear algebra and matrix inversion), it provides more information than is needed (it also provides estimates of the frequency, DC level, and signal amplitude), and it requires fairly good initial estimates of the four parameters DC, P, f, and Φ in order for it to converge to the correct result.

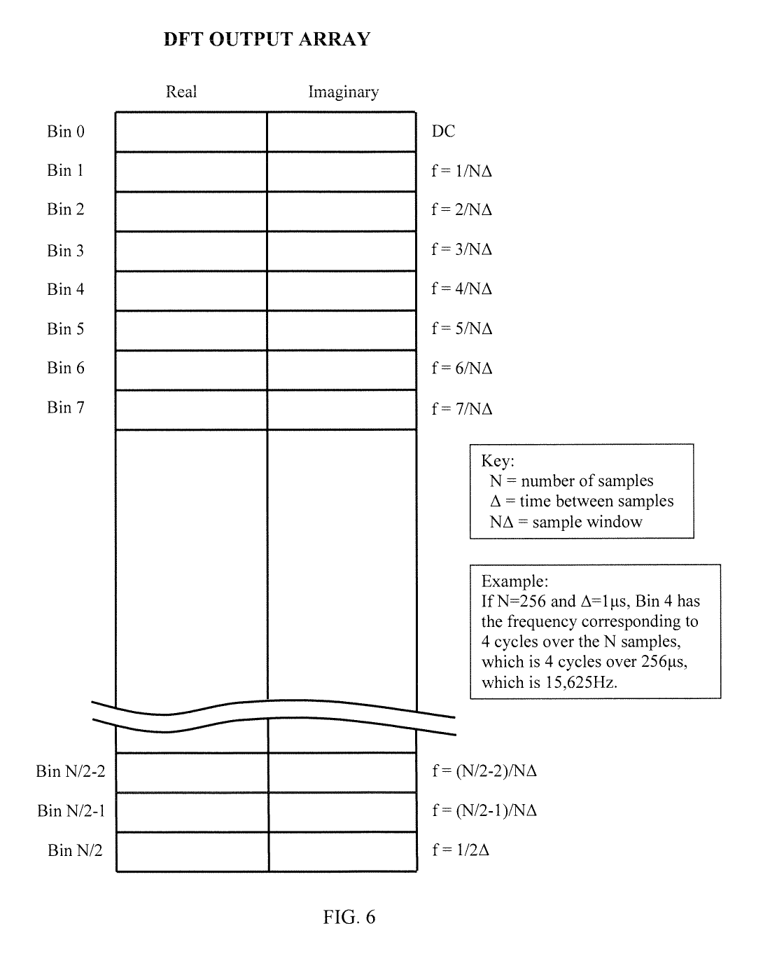

An alternate method for determining phase of a signal is by use of the Discrete Fourier Transform (DFT) algorithm. The DFT relies upon the periodic sampling and Fourier Transform principles to convert the sampled data in the time domain into the complex frequency domain. The output of the DFT process is a series of real and imaginary frequency bins as shown in FIG. 6. Note that higher sampling rates of the signal result in frequency bins having narrower width. The magnitude M of the signal at each frequency is

M=(real²+imaginary²)^{1/2} Equation 19

and the phase is

Φ=tan⁻¹(imaginary/real) Equation 20

What we wish to know of course is the phase of the signal at the dominant frequency. A way to do this is to compute the magnitude for each complex frequency, and then find the dominant frequency by selecting that frequency which has the greatest magnitude. Then the phase of the signal S is simply the phase of that dominant frequency as computed with Equation 20.

As an example, refer back to Equation 6, which is repeated here:

S₃=A_{FOS}+½A_{F}B_{F} cos(2πΔft−2πf_{DM}t−2πf_{M}τ_{PL}(t)−φ_{K}+φ_{F}−φ_{M}) Equation 6

The frequency term of the argument of the cosine function is 2πΔft, and lets suppose that f_{F}=2,401,015,000 Hz and f_{M}=2,400,998,000 Hz so Δf=f_{F}−f_{M}=17,000 Hz. If the time between samples is 10 μs, and there are 100 samples per DFT frame (i.e., the sampling window), then bin 17 has the complex frequency of the 17,000 Hz signal (17/(100×10⁻⁵)=17,000), and the phase of S₃ during the sampling interval is simply tan⁻¹(bin 17 imaginary value/bin 17 real value) per equation 20.

An alternate way of computing the phase is to determine the centroid of the individual cycles, or half-cycles, of the signal. The formula for determining the centroid of an arbitrary function of time, between a starting time tₛₜₐᵣₜ, and ending time t_{end} is

$$t = \frac{{\sum }_{n = {t}_{start}}^{{t}_{end}} ( {Area}_{n} \times {t}_{n} )}{{\sum }_{n = {t}_{start}}^{{t}_{end}} {Area}_{n}} \qquad Equation 21$$

where the n^{th} area is defined to be:

Areaₙ=n^{th} sample value×1/sampling rate Equation 22

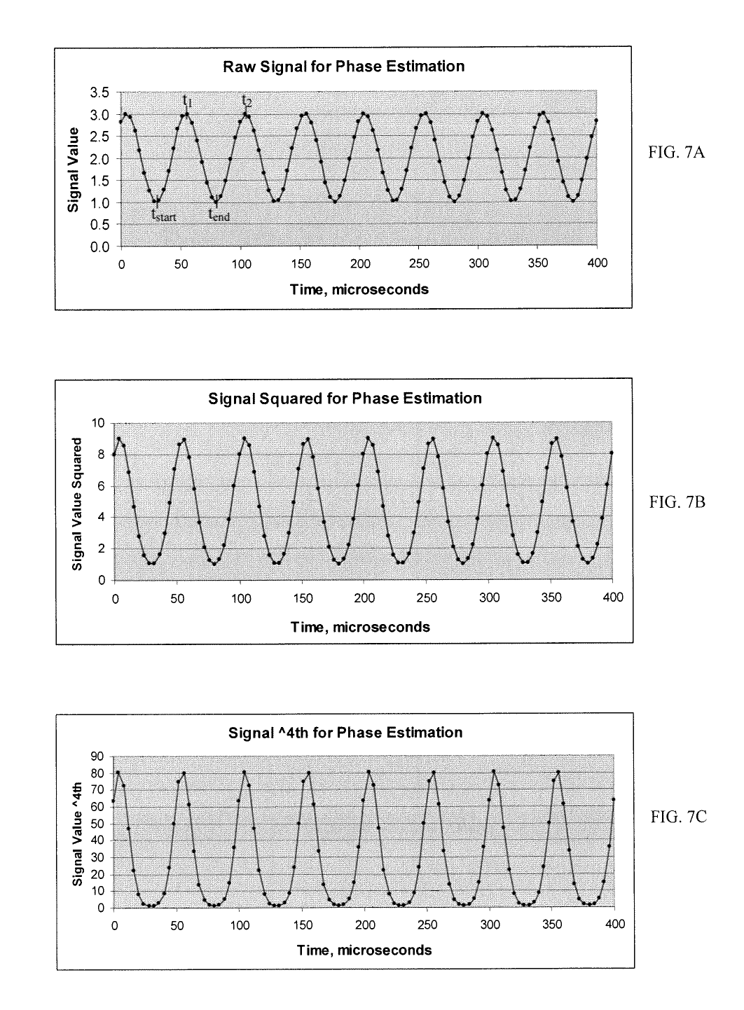

To find the centroid of a cycle of a sinusoid, such as S₃, per Equation 21, refer to FIG. 7A. In FIG. 7A, one cycle of the waveform is delineated by tₛₜₐᵣₜ and t_{end} which occur at the minimums of the waveform before and after the cycle, respectively. The center time t₁ of the cycle can be found by applying Equation 21 over the n sample points of the cycle. Next the center time t₂ of the following cycle is found, and the period of the sinusoid can be computed as Period=t₂−t₁. The phase of S₃ at t₁ is then simply Φ=(t₁−Period)×2π/Period. Note that the frequency can be found by simply taking the reciprocal of the Period, i.e., f=1/(t₂−t₁).

The centroid phase estimate can be improved in several possible ways. The first is to increase the sampling rate, so that more samples are available for use during the centroid computation. Secondly, instead of using two consecutive cycles for computing the Period, samples N apart can be used, and the resulting time difference between t_{N}−t₁ can be divided by N; i.e., Period=(t_{N}−t₁)/N. Thirdly, the sampled data can be squared, or even raised to the fourth power or more, as shown in FIG. 7B and FIG. 7C, respectively, which narrows the peaks and widens the troughs. Wider troughs reduce the sensitivity of the centroid algorithm to poor selections of tₛₜₐᵣₜ and t_{end} while also narrowing and localizing the center of the cycle even before the centroid computation is executed. Lastly, averaging over many values of centroids can improve the estimate of the Period, and low pass filtering (which is a form of weighted averaging) can reduce the uncertainty of the centroid calculation. Note that two or more of these techniques can be combined to improve the centroid phase estimate even further.

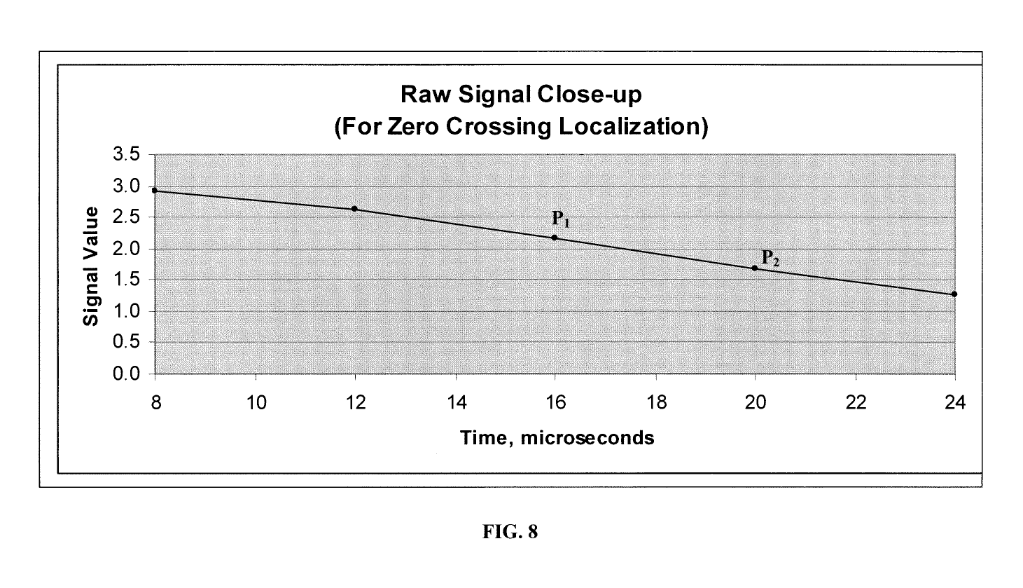

Yet another method for determining the phase of a signal such as S₃ or S₆ is by locating the zero-crossing positions in time, instead of locating the peaks or centroids as described above. The zero-crossing location is that location in time where the signal value crosses over the DC value. As noted earlier, the DC value can be readily found when the amplitude of the received signal is zero. Referring to FIG. 8, which is an enlargement of the curve of FIG. 7A about the first zero-crossing, and the points P₁ and P₂ lie on opposite sides of the crossing. The exact location of the zero crossing in time can be found with an interpolation process.

As an example, let P₁ have a value of 2.1629 volts at a time of 16.0 μs, and let P₂ have a value of 1.6675 volts at a time of 20.0 μs. The DC (zero crossing) value is known a priori to be 2.0 volts. Using interpolation we have the following expression:

$$\frac{{P}_{1} - D C}{{P}_{1} - {P}_{2}} = \frac{16 μs - {t}_{ZC}}{16 μs - 20 μs} \qquad Equation 23$$

where t_{ZC} is the unknown zero-crossing time we wish to find. In this example t_{ZC} turns out to be 17.3153 μs.

After the first zero crossing is found, one or more subsequent zero crossings will need to be found as well. The half-period of a cycle is that time between two zero crossings. Once the location of a zero crossing is found, and the period is known, the phase of the signal at the location of the zero crossing can be found with the use of the arithmetic illustrated earlier in connection with FIG. 7A.

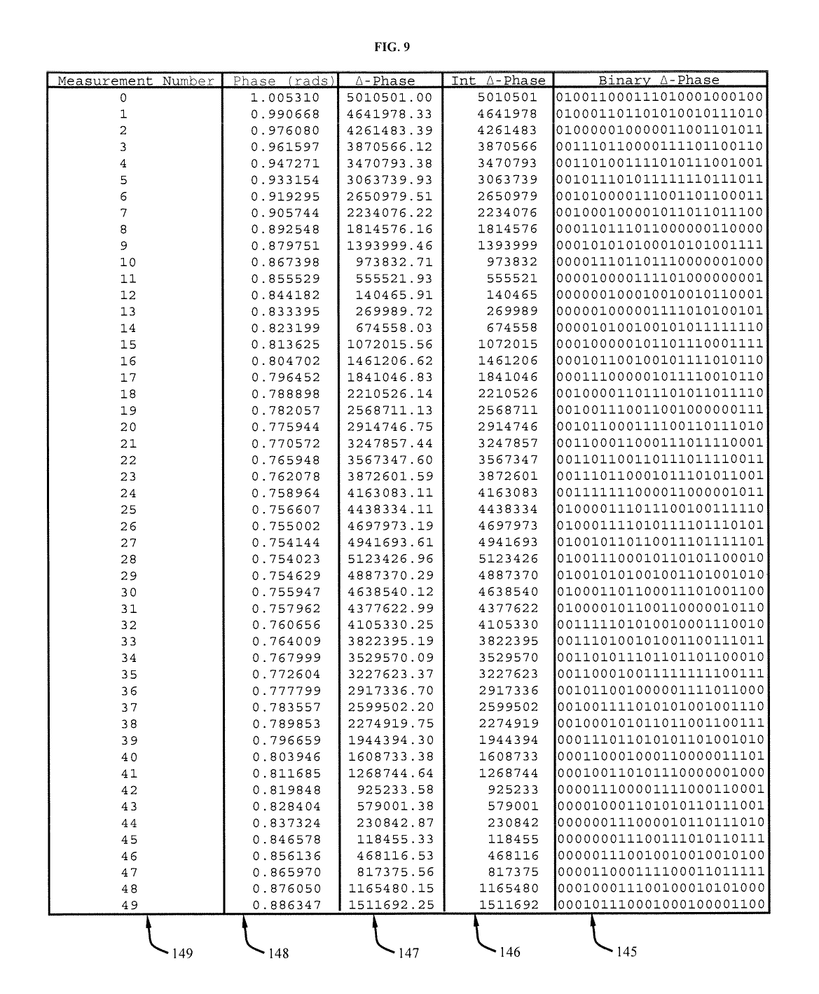

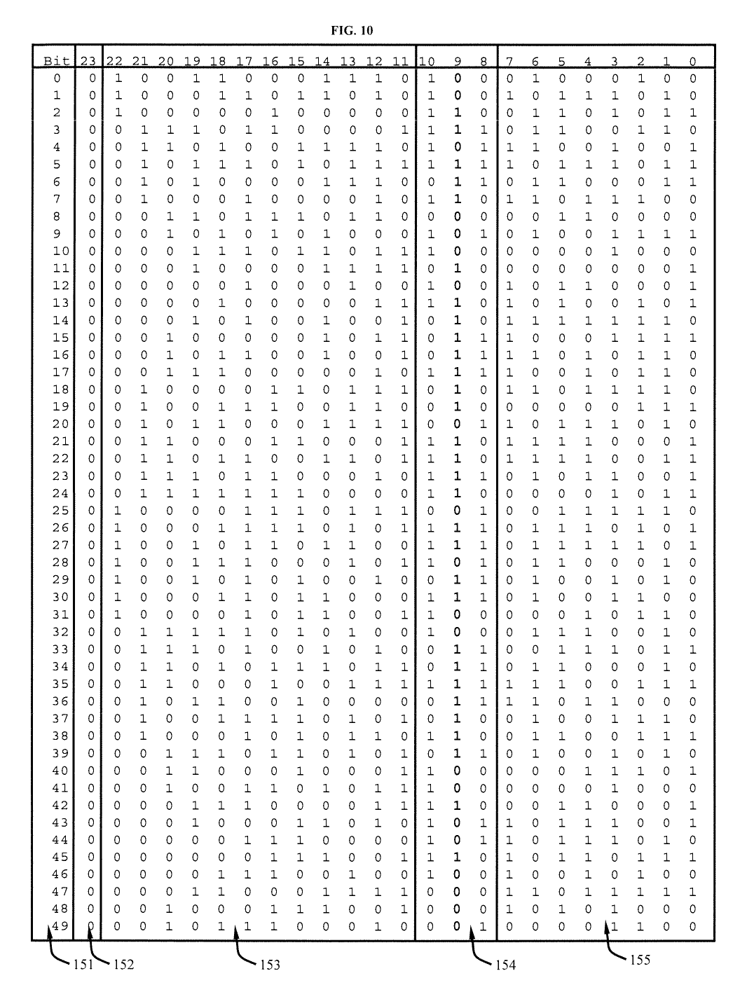

The phase determinations are made many times over the duration of a swipe. If a large sample data set is required for a phase estimate, such as the case if the non-linear regression or discrete Fourier Transforms are used and the sampling occurs over many cycles, then there may be just one phase computation per phase measurement. On the other hand, if a small sampled data set is required, such as for centroid estimation or zero-crossing estimation in which the sampled data are collected over only a few cycles, then several phase estimates can be combined together in an averaging algorithm. In any event, one phase measurement occurs during a measurement period, which is described in more detail in connection with FIG. 9 in the following paragraphs.

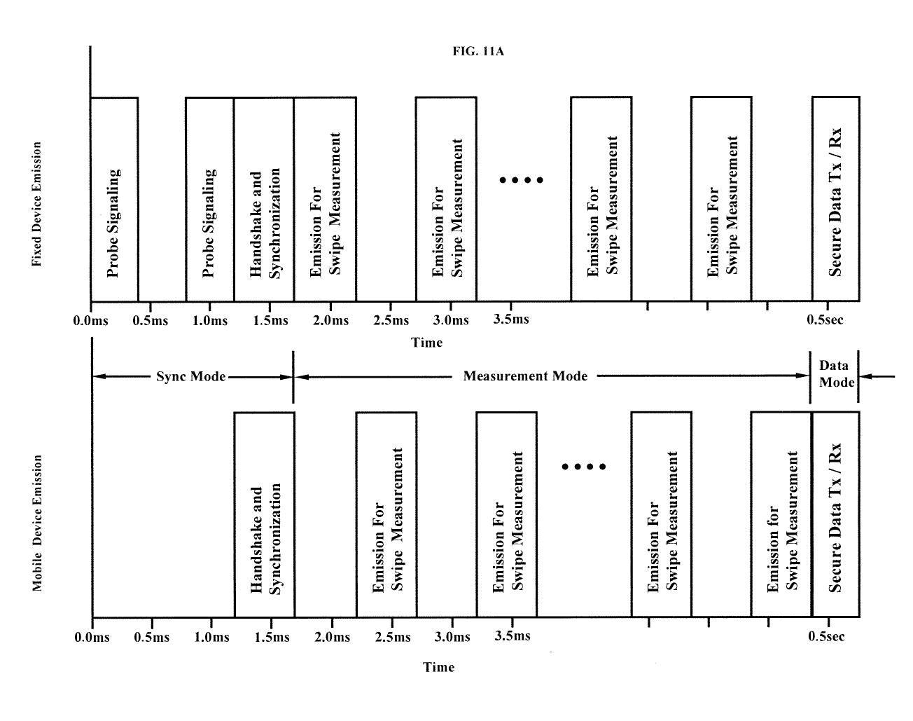

FIG. 9 and FIG. 10 presents a table of illustrative intermediate data values that might occur in the generation of the secret keys. Column 149 is the phase measurement number, although more than one column can be used as well. Exemplary phase measurements are presented in column 148, and they were computed from the varying swipe profile as described in detail above. Phase measurements 148 are typically floating point data types, although other data types can be used, such as integer. Each row represents a period of time in which the swipe profile is characterized. By way of example only, if the measurement duration is 0.5 seconds, and N=128 key bits, then each row represents 3.876 ms of time.

Column 147 is data of Δ-Phase (a.k.a Phase Velocity), of floating point data type although other data types can be used such as integer. This data is the difference between entries of the phase data of column 148. Recall that this operation is performed to eliminate the quasi-constant and unknown signal propagation time delays from the data, in accordance with Equations 10 through 13 above. Note that there will be one less entry or row of Δ-Phase data in column 147 than phase data of column 148.

Two other variations can occur while computing the Δ-Phase data in column 147. The first variation is that it is not necessary to use the difference between sequential entries in the Phase 148 column in the computation of the Δ-Phase data 147. Indeed, any bit-separation can be used from −N/2 to N/2 where N is the number of secret key bits being generated, as long as it is the same for the computation of each Δ-Phase data in column 147, and the same for both the fixed device 10 and a mobile device 40(1). Secondly, after the Δ-Phase data is computed, a multiplicative constant can be multiplied to each Δ-Phase in order to scale the differential value to a size that can fit comfortably into an integer word of the digital processor 12. For example, if the digital processor 12 has a sixteen bit data bus, meaning that the integer word size is 16 bits, then the Δ-Phase data needs to be scaled so that the magnitude of the largest Δ-Phase value is somewhat smaller than the value of 2¹⁶. Other integer word sizes may be 12 bit, 24 bit, 32 bit, although nearly any number of bits may be used to comprise an integer word.

After the Δ-Phase data 147 has been computed, the fractional part of each Δ-Phase datum 147 is discarded and the floating point data type is converted to an integer data type in a truncation operation. These integer Δ-Phase values are shown as column 146 in FIG. 9.

The integer Δ-Phase values of column 146 can also be equivalently treated as a column of binary data as illustrated in column 145. This column of binary data is actually a two dimensional table of binary data values, whose width corresponds to the number of bits in an integer word (24 bits in this example), and whose length is N, the number of secret key bits. This table of binary Δ-Phase data 145 is enlarged and described more fully in connection with FIG. 10.

Referring to FIG. 10 it is seen that the table of binary Δ-Phase data 145 of FIG. 9 can be expanded into four columnar regions of binary data. Column 151 of FIG. 10 is the same as column 149 of FIG. 9 and is simply the measurement number or equivalently, the secret key bit number.

Referring more specifically to FIG. 10, the binary format of the binary integer value of each of the Δ-Phase readings is illustrated. In this particular embodiment, the processing systems 12 and 42 in devices 10 and 40(1), respectively, determine that the bits fall into four different categories based on stored data which identifies which columns are measurably random and unaffected by noise based on the number of bits and sample sizes, although other manners for separating the bits into other numbers and types of categories can be used.

In the table of FIG. 10 the 24 bits of each integer word are enumerated across the top, with bit 0 being the least-significant bit, and bit 23 being the most significant bit. The most significant bit, in column 152, is notably a zero for each secret key bit number, and therefore is entirely unsuitable for use as a column of secret key bits. Similarly bits in group 153 suffer from serial correlation, in that a secret key bit is somewhat correlated with a preceding key bit, and these bits are therefore also unsuitable for use as secret key bits as their values can be predicted to some degree. This arises from these bits representing coarse changes in the movement of a mobile device 40(1) past a fixed device 10.

At the other extreme are a group of bits 155 at the least significant end of the integer word that are measurably random, and a column of which might be suitable for use as a series of secret key bits. Unfortunately this group of bits 155 are heavily influenced by noise that survived the averaging and filtering processes, and a column of these bits in a fixed device 10 will not match the same column of bits in a mobile device 40(1) because of the noise. Because they do not match, they are unsuitable for use as secret keys. The noise influencing the values of these bits arise from noise occurring in the reception of the transmitted signals 70 and 72 during Measurement Mode, the reception of these signals, or the processing of these signals.

Finally there exists a fourth group of bits 154 situated between the non-random bits 153 and the noisy bits 155 that are measurably random (i.e., do not suffer from serial correlation or other statistical defects) and do not suffer from noise to the extent that a column of these bits, such as the bits of bit-column 9, will be the same at the fixed device 10 as at the mobile device 40(1). By way of example, if this section 154 is three columns wide, such as in columns eight, nine, and ten, then one or more of the columns can be used. In this example, the bits in column nine are selected by the processing systems 12 and 42 in devices 10 and 40(1), respectively, to be the series of secret key bits, although two or more columns could be selected. These bits 154 are entirely suitable for use as a secret key for encrypting and decrypting data to be sent between the two devices 10 and 40(1). Accordingly, the bits in column nine for both devices 10 and 40(1) will be independently developed without transmitting the secret key or keys between the devices 10 and 40(1) and the secret key or keys will be identical at devices 10 and 40(1). In this example, the bits in column nine can now be used by the devices 10 and 40(1) as the secret key for applications, such as encrypting and decrypting data sent between devices 10 and 40(1) or providing for secure message integrity checks on data transmitted between devices 10 and 40(1) in manners well know to those of ordinary skill in the art.

While FIG. 10 shows only 50 rows (0 through 49) of secret key bits, the number of secret key bits can be controlled so that the number actually generated can be anywhere from one to over a million. In extreme cases even 2³² key bits can be created. This can be accomplished by increasing the duration of the swipe, or by increasing the number of phase measurements that are computed during the swipe, or both.

As mentioned earlier, during Measurement Mode each of the devices 10 and 40(1) emits an RF signal that is received at the other device, and the swipe profile is ascertained based upon the change in phase of the received signals. However, signal “collision” problems can occur during the transmission of the signals if the signals have substantially the same frequency and/or their emissions are not coordinated in time amongst the devices. To that end a transmitted signal synchronization scheme must be implemented.

FIG. 11A is a timing diagram illustrating one possible sequence of emissions by two devices 10 and 40(1) between which data is to be securely communicated. The upper diagram is the RF emission from the fixed device 10, and the lower diagram is the RF emission from a mobile device 40(1). The vertical axis on both diagrams represents the amount of RF energy being radiated, and the horizontal axis are the same and represent time. Note that the duration of the transaction is a little over a half-second in this example. Also note the presence of the three distinct sub-processes: a Sync Mode, followed by a Measurement Mode, followed by a Data Mode.

In the protocol illustrated in FIG. 11A, the secure transaction begins as the fixed device 10 is in Sync Mode and periodically emits a probe signal. If no reply is received to the probe signal, then the fixed device 10 assumes that a mobile device 40(1) is not present, and then re-emits the probe signal again. This continues until a mobile device 40(1) enters the broadcast area of fixed device 10 with the intent of establishing a secure data link. Such a mobile device 40(1) will then transmit a signal back to the fixed device 10, indicating its presence and intention to establish a secure data transaction.

After the probe signaling has been transmitted by the fixed device 10 and acknowledged by the mobile device 40(1), the two devices then enter a handshaking and synchronization sub-protocol within Sync Mode wherein the various channel parameters are exchanged, and the timing of the upcoming Measurement Mode signaling is established. The channel parameters that are communicated to one or the other of the devices are communicated unsecured, but may include non-sensitive information such as the number of key bits that are to be generated, the frequencies to be used during Measurement Mode, the Data Mode bit rate, who is to communicate secure data first, which bit column of bit group 154 to use as the series of secret key bits, the scale factor used during Δ-Phase computation, a frequency hopping schedule, and any other information useful for ensuring that the devices can generate identical secret keys. This Sync Mode probe, handshaking, and synchronization process may take as little as a few milliseconds of time, as illustrated in FIG. 11A, or it can take tens of seconds or more, but generally it will occur only during a small initial portion of a swipe.

Once the synchronization is complete, then both devices enter Measurement Mode and begin transmitting measurement signals to the other device. As shown in FIG. 11A, the transmissions are short, on the order of 0.5 ms, and at no time are both the fixed device 10 and a mobile device 40(1) transmitting at the same time. As an example, if the transmissions each last 0.5 ms, and if the resulting heterodyned signal S₃ or S₆ has a frequency of 10 KHz, then five cycles of S₃ or S₆ will be available for phase computation, as described above. The transmission of Measurement Mode signals continues until enough swipe profile phase measurements have been made to generate the desired number of secret key bits. The Measurement Mode signaling process typically consumes the majority of the time of the secure data transaction process, especially if only a small amount of data, such as a credit card number, is to be transmitted from a mobile device 40(1) to the fixed device 10. However, if a lot of data is to be securely communicated, such as when a file is to be transmitted from a “memory-stick” type of mobile device 40(1) to the fixed device 10 (which may be a personal computer, for example), then the data transmission may consume the majority of the time of the secure data transaction process.

Once the Measurement Mode is completed and the secret keys are generated, the devices 10 and 40(1) will enter Data Mode. At this time the data that is to be sent over the secured radio channel is encrypted using the secret keys that were created with the phase data collected during Measurement Mode as described earlier, at one of the devices, and the encrypted data is then transmitted over the RF link to the other device. The other device then receives the encrypted data, and decrypts the data using the secret keys that the receiving device also generated during Measurement Mode. Then, optionally, data can be sent in the opposite direction, and even back and forth, encrypted, until all of the data that needs to be sent has been sent. Then the secure link is terminated, and each of the devices 10 and 40(1) simply discards the secret keys that were used for securing the radio communication link.

As part of the data communication process, the digital data can include message error detection characters, such as a CRC (Cyclic Redundancy Code) or checksum. There can also be error detection and correction characters included that are based upon Golay, Reed-Solomon, or any other forward error detection or correction algorithm known to those skilled in the art.

It is very important to note that at no time was key information sent between the devices, or indeed, transmitted over the air for an eavesdropping party to intercept. All that was transmitted over the air for an eavesdropper to listen to was the probe signal, the handshaking signal, the synchronization signal, the Measurement Mode signal, and encrypted data. That is, at no time was any information transmitted that would allow an eavesdropper the ability to decrypt the encrypted data, or to forge a message packet if message integrity checking is employed.

The preceding example described in connection with FIG. 11A assumed that it was not permissible for the two devices 10 and 40(1) to transmit RF signals at the same time, and therefore the transmissions were forced to occur in non-overlapping time slots. The reason the two devices may not be allowed to transmit at the same time may be because they are transmitting on the same frequency, or because if they are transmitting on different frequencies the T/R isolators 24 and 54 may be inadequate to separate the transmitted and received signals at the device.

If, however, the T/R isolators 24 and 54 are able to satisfactorily prevent the transmitted radio signal from entering the receiving amplifier at the communicating devices 10 and 40(1), then it is possible for a device to transmit and receive measurement signals at the same time, provided the transmission frequency is not the same as the frequency of the signal that is being received. (It must be kept in mind, however, that the frequency difference cannot be too large or the computation identical Δ-Phase values during Measurement Mode breaks down). If different frequencies are used, a timing diagram such as that of FIG. 11B can be adopted. Note that the ability to transmit and receive measurement signals concurrently allows for a shorter swipe duration, more averaging and filtering during key generation, or for the creation of more key bits during the same swipe duration.

Yet another timing diagram is illustrated in FIG. 11C. In this case the T/R isolator 24 or 54 is again able to prevent transmission signals from reaching the receiving amplifier within a fixed device 10 or mobile device 40(1), and the devices are able to transmit and receive measurement signals of different frequencies at the same time. However, the frequency of the RF measurement signals are not substantially constant, and can change from moment to moment in a pre-arranged fashion. This is known as frequency hopping, and can add yet another layer of security to the creation of the secret key bits.

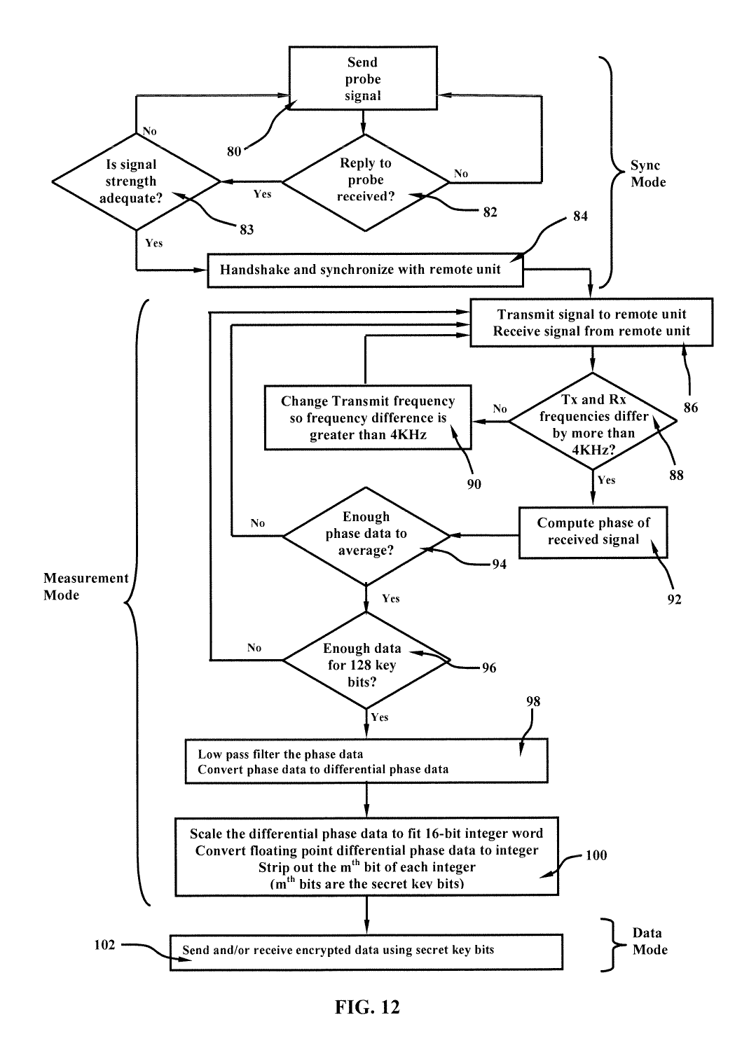

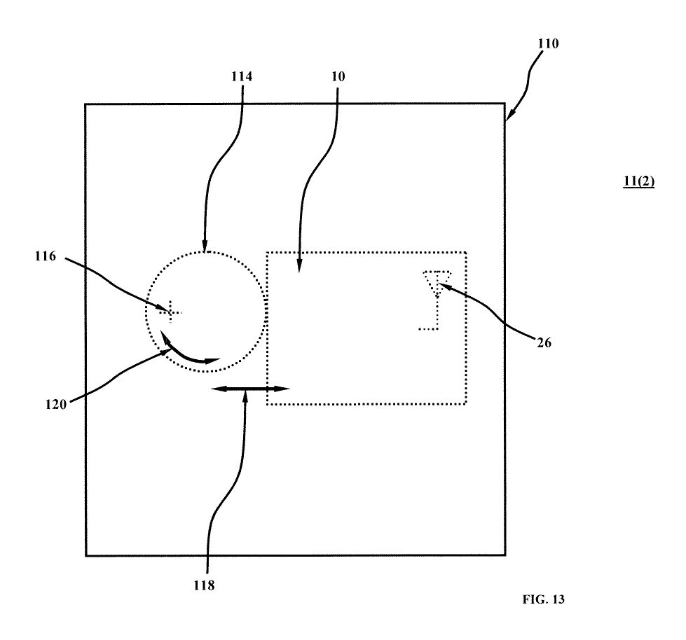

The present invention generates bits for a secret key substantially simultaneously between devices 10 and 40(1) based upon the common swipe profile between them. The key bits are not communicated between the two devices, but are independently generated and are identical. In particular for these embodiments of the present invention, a flowchart of a method for generating one or more secret keys is illustrated in FIG. 12.

In step 80 of FIG. 12., in which the devices 10 and 40(1) are in Sync Mode, the fixed position device 10 using the transmitter signal generator 14, the transmitter 20 and the antenna 26 periodically sends out a probe signal to identify the presence of a mobile device 40(1), although other manners for identifying the presence of a mobile device 40(1) with respect to fixed device 10 can be used. For example, the probe signal can be sent in other manners, such as randomly, and the mobile device 40(1) could send probe signals to identify the presence of the fixed device 10. When the probe signal is received by the device 40(1), device 40(1) transmits a radio signal using the transmitter signal generator 44, transmitter 50 and antenna 56 acknowledging that the probe signal has been received.

The probe signal and/or the response to the probe signal may need to be enabled by a user at one of the devices 10 or 40(1). This enabling can be accomplished by the act of entering in a password, PIN number, voice activation, by activating a switch, or by the use of a biometric characteristic of the user such as a thumb or fingerprint scan, or eye-scan, although other authentication techniques could be used.

In step 82, the fixed position device 10 using receiving amplifier 22, demodulator 18, and digital processor 12 determines if a reply has been sent from the mobile device 40(1) and received at the fixed device 10. If a reply to the probe signal is not received, then the No branch is taken back to step 80. If a reply to probe signal is received, then the Yes branch is taken to step 83.

In step 83, the digital processing device 12 determines if the signal strength of the reply to the probe signal is adequate by comparing the amplitude of the reply signal to a threshold stored in memory in the digital processing device 12, although other manners for determining if there is adequate signal strength can be used and other ways of obtaining the threshold can be used. In this particular embodiment, the processing device 12 determines the amplitude by simply noting the maximum and minimum amplitude of the samples of the received reply signal S₃. With some locations and positions of the fixed position device 10 with respect to the mobile device 40(1), the signal strength may not be adequate to obtain suitable or reliable measurements of the movement of the mobile device 40(1) over a period of time. If the signal strength does not exceed the threshold, then the No branch is taken back to step 80. If the signal strength does exceed the threshold, then the Yes branch is taken to step 84.

In step 84, where the devices 10 and 40(1) are still in Sync Mode, the fixed position device 10 and a mobile device 40(1) conduct a handshake and synchronization process. As illustrated in FIGS. 11A through 11C, the handshake and synchronization operations are fairly short and are followed by several emissions described below. Since techniques for handshaking and synchronization between devices are well known to those of ordinary skill in the art, they will not be described in detail herein.

In step 86, the communicating device 10 and 40(1) have left Sync Mode and entered Measurement Mode, and radio signals are sent and received by the two devices 10 and 40(1) so that the relative motion between devices 10 and 40(1) can be measured by each of the devices 10 and 40(1) over a period of time occurring over one or more swipes or passes. By way of example, device 10 will emit radio energy 70 from antenna 26 which will be received by antenna 56 and receiving amplifier 52 and processed by the demodulator 48 and digital processor 42. Interleaved with this signal transmission, or operating at a different frequency, device 40(1) will emit radio energy 72 from antenna 56 which will be received by antenna 26 and receiving amplifier 22 and processed by the demodulator 18 and digital processor 12.

As illustrated in FIGS. 2B, 3A, and 3B, the mobile device 40(1) moves in a swiping motion along a direction of arrow 74(1) by fixed position device 10, although the device 10 could move with respect to device 40(1) or both devices 10 and 40(1) could be moving. This unique change in position for each swipe or pass of device 40(1) by device 10, results in a changing separation distance 62 between devices 10 and 40(1) which is used for generation of one or more secret keys. This single swipe in which device 40(1) moves past device 10 just once will in general have a varying distance 62 between the devices such that the start and end distances of the swipe are greater than a mid-swipe distance. This change in distance 62 over time also results in a varying velocity between the devices 40(1) and 10 as well. Although device 40(1) is shown moving and device 10 is fixed, other configurations can be used, such as having both devices moving with respect to each other.

Although one swipe or pass as illustrated in FIG. 3A, other numbers of swipes or passes could be used to capture measurement data and provide even greater security, such as the double swipe or pass illustrated in FIG. 3B. Just as no two snowflakes are identical, no two swipes will be substantially identical owing to the user-induced variations of motion of a mobile device 40(1). The double-pass swipe has the advantage over a single swipe because the path signature will be even more unique, will be of longer duration, and can potentially produce a more robust set of bits for generating the one or more secret keys.

The next step 88 after receiving a measurement signal is to determine if the difference in frequency is greater than a certain threshold, such as 4 KHz. Recall from the processing of heterodyned signals S₃ and S₆ that if the frequency of these signals, which is substantially the same as the difference in frequency of the transmitted and received signals (or the difference in frequency of the received signal and the local oscillator), then the phase determination process becomes difficult and inaccurate. If the frequency difference between the transmitted and received frequency is less than a threshold such as 4 KHz, then the No branch is taken to step 90. Otherwise if the frequency difference between the transmitted and received frequency is greater than a threshold such as 4 KHz, then the Yes branch is taken to step 92. Note that 4 KHz is an example, and other frequencies can be used, such as 20 KHz, or the frequency test of step 88 can be dispensed with.

If the No branch is taken from step 88, processing continues at step 90, where one or both of the devices 10 and 40(1), but not both, must change the radio transmission frequency so that the difference in receive and transmission frequencies is greater than the threshold. An example of this can follow from the Bluetooth radio specification, where the center radio frequencies are in channels having nominal center frequencies of 2.400 GHz, 2.401 GHz, 2.402 GHz, and so on, with ±75 KHz tolerances on the center frequency. Typically, due to the rather large tolerance on the center frequency, the difference in received signal frequency will be different than the transmitted signal frequency, even when operating at the same channel and same nominal center frequency, and the frequency of heterodyned signals S₃ and S₆ will be large enough so that their phases can be determined as described earlier. However, there will be times when the transmitted radio signal and the received radio signal are approximately the same, in which case S₃ and S₆ will be too low in frequency for phase determination. If this were to happen, it can be remedied by changing the parameters of the transmitter signal generator 14 so that the transmitted frequency is at the center frequency of the next higher (or lower) channel. For example, the transmitter frequency may be increased from 2.401 GHz to 2.402 GHz. In this case the difference in frequency is increased by approximately 1 MHz, which can be readily processed for phase determination. After the transmission frequency change is made, processing returns to step 86. Furthermore, once it has been determined that the frequency difference is above the threshold, then it can be assumed that the frequency difference will remain adequate during the remainder of Measurement Mode, and processing step 88 can be skipped for the balance of Measurement Mode (ie, processing will proceed directly from step 86 to 92).

If the Yes branch is taken from 88, processing continues at step 92. At step 92 the phase of the received signal is computed using any of the four methods (DFT, centroid, zero crossing, non-linear regression) described earlier. The computed phase estimate is then stored in memory within the digital processor 12 for further processing.

In step 94, the digital processors 12 and 42 in devices 10 and 40(1), respectively, determine if enough phase measurements have been obtained to average, although the averaging step can be eliminated if the number of samples that the phase-computing algorithm operates on is large—as might be the case with the G-N algorithm. Typically, in most measuring devices that operate in an open medium, such as air or free space, stray and ambient signals, such as radio frequency interference in the RF spectrum, or stray light in the optical spectrum, will create electronic noise that reduces the precision of the quantity being measured. To offset this problem, the measurements can be made over multiple time periods which are then averaged together to improve the SNR and measurement precision. This can result in several thousand cycles of the signals S₃ and S₆ being processed in each of the devices 10 and 40(1), respectively, during a swipe of device 40(1) by device 10.

By way of example only, if each radio signal emission during Measurement Mode lasts 0.5 ms, and the Off time between emissions is also 0.5 ms in which the other device is emitting a Measurement Mode signal, then there will be approximately 500 emissions of RF signal by each device during Measurement Mode. If each received emission results in one phase estimate, and if it desired to have 125 secret key bits, then 500/125=4 consecutive phase estimates resulting from the reception of four consecutive signal transmissions of the opposing device can be averaged together in order to provide a more robust (i.e., less noisy) estimate of the phase. That is, since one or more key bits are later obtained from each averaged measurement, greater precision for each average measurement for each of the devices 10 and 40(1) results in greater precision on each integer Δ-Phase computation from which the key bits are extracted.

Alternately the averaging process can be skipped, in which case the Measurement Mode processing is simplified and a potentially greater number of (non-averaged) secret key bits can be obtained.

Another averaging scheme is a so-called box-car or moving average, in which a moving window is slid, one array position at a time, across the array of phase estimates, and the values within the window are averaged together. In this way an array of length A phase or Δ-Phase estimates can yield a number of A or A-1, respectively averaged phase or Δ-Phase measurements (ignoring end effects at the beginning and end of the array) from which A or A-1 key bits, or an integer multiple of A or A-1 key bits, can be extracted.

Note that the averaging process can be executed at any of one or more different places within the data processing path, including the raw sampled data which is input to the phase estimation process, the phase values themselves φ₃ and φ₆, which are output from the phase estimation process, or on the Δ-phase data ΔΦ₃ and Δφ₆. The number of values used during an averaging process can be from 2 to 10,000,000.

Accordingly, if in step 94 the processing systems 12 and 42 in devices 10 and 40(1), respectively, determine that not enough estimates of the phase have been obtained to average, then the No branch is taken back to step 86 where additional emissions are made and received signal samples are collected. If in step 94 the processing systems 12 and 42 in devices 10 and 40(1), respectively, determine enough estimates of the phase have been obtained to average, then the Yes branch is taken to step 96.

In step 96, the processing systems 12 and 42 in devices 10 and 40(1), respectively, determines if the number of collected phase estimates is large enough in order to generate the desired number of secret key bits, being 128 in this example, although other numbers of key bits with other requirements for obtained data could be used. Typically, the length of the secret key bit sequence required by many popular encryption methods is 128 bits, although again other numbers of key bits could be used depending on the desired degree of data security, such as 256 bits. If the processing systems 12 and 42 in devices 10 and 40(1), respectively, determine enough phase measurement data has not been obtained to generate 128 key bits, then the No branch is taken back to step 86 to obtain additional phase measurements. If the processing systems 12 and 42 in devices 10 and 40(1), respectively, determine enough phase measurement data has been obtained to generate 128 key bits, then the Yes branch is taken to step 98.

In step 98, the processing systems 12 and 42 in devices 10 and 40(1), respectively, convert the phase measurements to Δ-Phase, although other conversions could be performed, such as converting phase to phase acceleration. Phase Velocity or Δ-Phase readings are used because most signal processing systems have a quasi-constant signal propagation time delay (i.e., τ₁, τ₂, τ₃, and τ₄) that varies from unit to unit. These time delays makes it difficult for two devices 10 and 40(1) to measure the exact same phases during a swipe, thus resulting in different bits for the secret key. However, the computation of Δ-Phase being a time rate of change of phase, inherently subtracts out the offset such that the “phase velocity offset” is zero. As a result, bits generated from the Δ-Phase (i.e. phase velocity) readings obtained from the averaged phase measurements for the devices 10 and 40(1) will be identical. Although phase velocity is used, other converted parameters could be used, such as phase acceleration obtained from the Δ-Phase measurements, and the phase acceleration data could be used to generate the bits for the one or more keys.

The phase velocity (Δ-Phase) is computed by the processing systems 12 and 42 in devices 10 and 40(1), respectively, as the difference between two phase measurements divided by the time between them. This division operation, in which the change in phase is divided by a constant differential time value, performed by the processing systems 12 and 42 in devices 10 and 40(1), respectively, is essentially a scaling operation since the differential time value is a constant. Since the change in phase between two sequential phase measurements can be small, not much larger than the residual noise level still present after the averaging process, the processing systems 12 and 42 in devices 10 and 40(1), respectively, select phase measurements whose differential values are more likely to be greater. By way of example only, the processing systems 12 and 42 in devices 10 and 40(1), respectively, may select one averaged phase measurement obtained at the start of a swipe and one averaged phase measurement obtained at the middle of a swipe, for a single-swipe system. Alternately, with a double-swipe pass where 128 key bits are desired, the processing systems 12 and 42 in devices 10 and 40(1), respectively, may select the start of the first swipe (measurement 0), the end of the first swipe (usually measurement 64) which is also the start of the second swipe, as well as the end of the end of the second swipe (measurement 128) as being the phase extrema corresponding to the longest swipe gap distances. The shortest distances are likely to be in the middle of the two swipes (measurements 32 and 96). Therefore, the maximum difference in distances is likely to be obtained when the offsets are 32 measurements apart.

Similarly, changes in phase velocity, a.k.a. phase acceleration can also be used by the processing systems 12 and 42 in devices 10 and 40(1), respectively, to generate the bits for the one or more secret keys. The phase velocity or phase acceleration values used in the computation by the processing systems 12 and 42 in devices 10 and 40(1), respectively, can be adjacent values, giving rise to phase acceleration or they can be non-adjacent values, such as those having for example a separation of 32 measurements as described earlier.

In step 98, after a number of phase measurements are converted to Δ-Phase, the Δ-Phase data can be further filtered to reduce any residual noise effects. With the optional filtering, the one or more keys generated in one device 10 are even more likely to match the one or more keys generated by the other device 40(1). The filtering is usually a low-pass filter, such as a “box-car” average which is essentially a convolution function with unity coefficients, or it can be an IIR (infinite impulse response) or FIR (finite impulse response), whose width and coefficients can be determined such that a desired filter function can be generated, although other types and numbers of filters could be used such as Kalman filtering, which can be used to help predict the motion of the devices in time.

Alternately in step 98, the filtering can occur on the phase measurements before they are converted to Δ-Phase data, or filtering can occur on both the raw phase data and the Δ-Phase data.

Since the structure and operation of digital signal processing and filtering systems are well known to those of ordinary skill in the art, they will not be described in further detail here.

In step 100, the processing systems 12 and 42 in devices 10 and 40(1), respectively, a bit is selected from each integer Δ-Phase or phase velocity datum to generate the secret key, although other numbers of bits could be selected from other types and numbers of converted measurements, such as selecting a bit from an acceleration reading. The bit selection process was described earlier in connection with FIGS. 9 and 10.

After the secret key bits have been generated at each of the devices 10 and 40(1), processing continues on to step 102 in which the communicating devices 10 and 40(1) have left Measurement Mode and entered Data Mode. In step 102 the data to be sent between the devices is encrypted in a digital processor 12 or 42 with the secret keys previously generated, and then modulated by a modulator 14 or 44 into an analog format, and the analog signal is thus transmitted by a transmitter 20 or 50 through an antenna 26 or 56 into an over the air radio broadcast 70 or 72. Next the radio broadcast is received by an antenna 56 or 26, the received signal is amplified by receiving amplifier 52 or 22 and subsequently demodulated by demodulator 48 or 18, which outputs digital data (encrypted digital data) to the digital processor 42 or 12 whereupon the encrypted data is decrypted using the secret keys generated in steps 86 through 100 of Measurement Mode.

Although in this particular embodiment, the system 11(1) comprises the fixed position device 10 and mobile device 40(1) are shown, the system 11(1) could comprise other types and numbers of devices in other configurations. By way of example only, multiple fixed position devices 10 and multiple mobile devices 40(1) could be arranged in a network configuration over which each pair of devices generates a shared key.

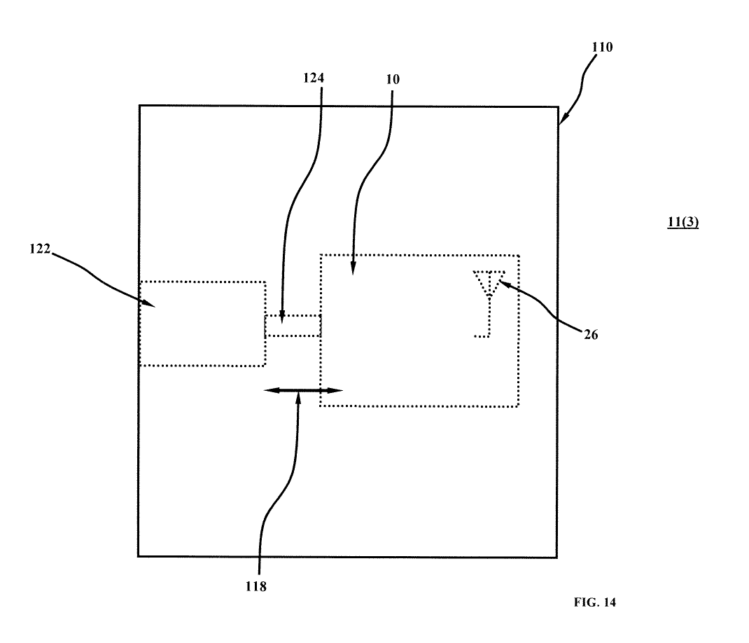

Another system 11(2) for generating one or more secret keys in accordance with other embodiments of the present invention is illustrated in FIG. 13. System 11(2) is the same as system 11(1) except as described herein. In system 11(2), the fixed position device 10 is enclosed in an opaque housing 110. Additionally, a cam system 116 is coupled to the fixed position device 10, although other types and numbers of cam systems or other movement systems can be used. When the cam system 116 is rotated in the direction of arrow 120, the cam system 116 causes the fixed position device 10 to move longitudinally in the direction of arrow 118, although the cam system 116 can be positioned to move the fixed position device 110 in other directions. For example, the cam system 116 could be coupled to a side of fixed position device 10 perpendicular to the connection side illustrated in FIG. 13 which will laterally move the fixed position device 10. In another example, two or three cams systems can simultaneously be used to move the fixed position device 10 in two or three different axis, respectively. The rotation of the cam system 116 is at continuous constant rotational velocity, although the cam system 116 can be rotated in other manners, such as randomly, periodically, pseudo-randomly, or with a chaotic velocity. This embodiment has the extra advantage of an additional amount of entropy that is beneficial to the key generation process, although it has the disadvantage of increased cost and complexity.

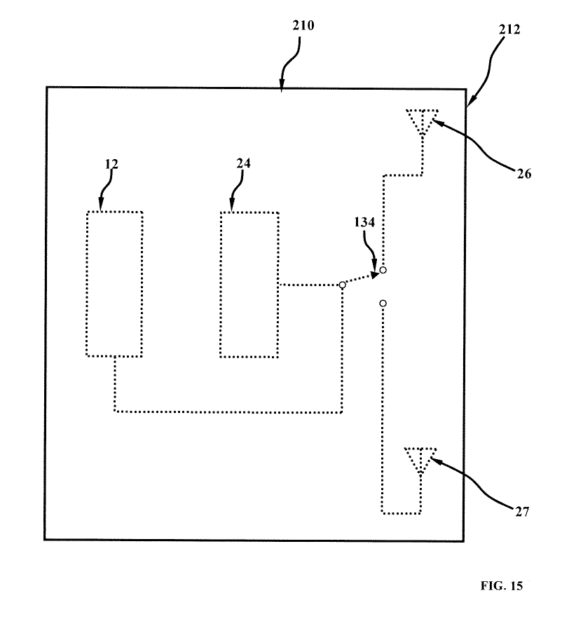

Another system 11(3) for generating one or more secret keys in accordance with other embodiments of the present invention is illustrated in FIG. 14. System 11(3) is the same as system 11(1) except as described herein. In system 11(3), the fixed position device 10 again is enclosed in an opaque housing 110. Additionally, an actuator system 122 which a driving shaft 124 is coupled to the fixed position device 10, although other types and numbers of actuator systems or other movement systems can be used. When the actuator system 122 is engaged, the actuator system drives the shaft 124 to longitudinally move the fixed position device 10, although the actuator system 122 can be positioned to move the fixed position device 10 in other directions. For example, the actuator system 122 could be placed on a side of the fixed position device 10 perpendicular to the connection side illustrated in FIG. 14 which will move the fixed position device 10 laterally. In another example, two or three actuator systems 122 can be simultaneously used to cause the fixed position device 10 to move in two or three axis, respectively. The movement of the actuator system 122 is periodic, although other movements of the actuator system 122 can be used, such as randomly, pseudo-randomly, or with a chaotic motion. This embodiment has the extra advantage of an additional amount of entropy that is beneficial to the key generation process, although it has the disadvantage of increased cost and complexity.

Another embodiment for a fixed device is illustrated in FIG. 15. The fixed device 210 of FIG. 15 is the same as the fixed device 10 described earlier in connection with FIGS. 1, 2A, 2B, and 4, except for the following differences. Fixed device 210 has an antenna 26, but also has an additional one or more antennae 27 that is connected to the T/R isolator 24 through the addition of a switch 134. Only one antenna 26 or 27 is used at a time, and it will be used for both transmission and reception of modulated or unmodulated signals depending on whether the device 10 is in Sync Mode, Data Mode, or Measurement Mode, respectively. The switch 134 is also connected to the digital processor 12, which controls the position of the switch 134, and thereby determines which antenna 26 or 27, is in use. The switch 134 can be a single-pole multiple-throw switch, where the number of switch positions corresponds to the number of antennae used in the system. Typically the antennae 26 and 27 are located a distance apart that is greater than the wavelength of the radio emission. Furthermore, the antennae 26 and 27 are located in an opaque, albeit non-conducting, housing, so their relative positioning cannot be viewed.

In operation the digital processor 12 will command the switch 134 to change positions so that different antennae are utilized during Measurement Mode.

In particular, if the transmit and receive frequencies are the same, the switching will occur between transmit and receive time slots as illustrated in FIG. 11A. If the transmit and receive frequencies are substantially different, as is the case described in FIGS. 11B and 11C, then the digital processor 12 can command the switching to occur at any time during Measurement Mode. Ideally, however, in this example it is preferable for the switching to occur between phase estimate computations, and not during the middle of a phase computation because the phase measurement will be distorted if the switching while phase data samples are being collected.

The multiple-antenna configuration of FIG. 15, the linear actuator configuration of FIG. 14, and the cam configuration of FIG. 13 all serve to provide an additional degree of movement, or effective movement, that is unviewable to the outside world. These means therefore provide an extra degree of entropy that makes it even more difficult for an undesirable party to successfully eavesdrop on the radio emissions and independently generate the secret key bits.

Heretofore the emissions have been described as being radio frequency (less than 10 GHz), although other portions of the electromagnetic spectrum can be used instead. For example, instead of an RF carrier, the emission can be optical, having a wavelength between 0.4 μm and 1.6 μm. If an optical emission is used, it will have to be modulated, in particular amplitude modulated, according to the mode of operation of the devices. For example, during Sync and Data Modes, the signals and characters will be communicated to the opposing device by a binary ON/OFF modulation of the light. During Measurement Mode the measurement signal will be comprised of the optical carrier which is amplitude modulated at a frequency between 100 MHz and 2 GHz during the ON portions. The hardware of the optical embodiment will also differ somewhat from the RF hardware, in that a light source, such as an LED or laser, will replace the transmitter, and a light detector, such as a photodiode, will replace the receiver. The T/R isolator 24 is not needed in an optical embodiment.

Accordingly, as illustrated herein the present invention provides an effective and secure method and system for simultaneously and independently generating one or more secret keys for encrypting and decrypting data sent between devices based on measurements of the phase of a received signal that was transmitted by a device and varies in accordance with the time-varying swipe gap distance 62 between and common to the devices. The present invention also is an effective and secure method for simultaneously and independently generating one or more secret keys that provide for secure message integrity checks on data transmitted between devices. These generated secret keys can be used in standard cryptographically-secure communication schemes

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for independently generating one or more keys at two or more devices, the method comprising:
transmitting a signal from the two or more devices;
receiving at each device a signal transmitted from the other one or more different devices;
processing the received signal at each device to obtain data based on movement of at least one of the devices with the respect to the other device;
and generating one or more keys based on the obtained data at each of the devices for use in securing communications between the devices, wherein the one or more keys at each of the devices is substantially the same.

2. The method as set forth in claim 1 wherein the obtaining the data further comprises obtaining the data in response to movement of at least one of the devices with the respect to the other device during one or more passes between the devices.

3. The method as set forth in claim 2 wherein the obtaining the data further comprises obtaining the data during two or more passes between the devices.

4. The method as set forth in claim 1 wherein the obtained data comprises one of phase and phase-velocity measurements.

5. The method as set forth in claim 1 wherein the frequency of the transmitted signal is unknown.

6. The method as set forth in claim 5 wherein the frequency of the transmitted signal is unknown but less than a maximum frequency.

7. The method as set forth in claim 1 wherein the transmitted signals from the two or more devices are interleaved in time.

8. The method as set forth in claim 1 further comprising providing a frequency generating system in each of the one or more devices.

9. The method as set forth in claim 8 wherein the transmitted signals from the two or more devices are substantially the same, wherein any frequency differences are caused by tolerances of the one or more of the frequency generating systems.

10. The method as set forth in claim 1 wherein the transmitted signal of one device is of a substantially different frequency than the frequency of the transmission of the other devices.

11. The method as set forth in claim 1 wherein the obtained data comprises phase measurements

12. The method as set forth in claim 11 wherein further determining if the range of phase measurements are greater than a threshold, wherein the generating the key generates when the range of phase measurements are greater than the threshold.

13. The method as set forth in claim 11 wherein the phase determining is made with a Discrete Fourier Transform.

14. The method as set forth in claim 13 wherein the Discrete Fourier Transform is a Fast Fourier Transform.

15. The method as set forth in claim 11 wherein the phase determining is made with a curve-fitting algorithm.

16. The method as set forth in claim 15 wherein the curve-fitting algorithm is a non-linear regression algorithm.

17. The method as set forth in claim 16 wherein the non-linear regression algorithm is a Gauss-Newton algorithm.

18. The method as set forth in claim 11 wherein the phase determining is made with a centroid determining algorithm.

19. The method as set forth in claim 11 wherein the phase determining is made with a zero-crossing determining algorithm.

20. The method as set forth in claim 1 further comprising determining if the obtained data is less than a data threshold for the generating the one or more keys, wherein the obtaining the data obtains additional data if the obtained data is less than the data threshold.

21. The method as set forth in claim 1 further comprising averaging one or more portions of the obtained data, wherein the generating the one or more keys is based on the averaged portions of the obtained data.

22. The method as set forth in claim 1 further comprising filtering the obtained data before the generating the one or more keys.

23. The method as set forth in claim 1 further comprising providing a local oscillator.

24. The method as set forth in claim 23 wherein the processing the received signal further comprises heterodyning the received signal with a signal from the local oscillator.

25. The method as set forth in claim 23 wherein the received signals and the local oscillator signal are substantially the same, wherein any frequency differences between the signals are caused by one or more of the tolerances of the one or more of the frequency generating systems and the tolerance of the frequency of the local oscillator.

26. The method as set forth in claim 1 wherein the generating the one or more keys further comprises:
converting the obtained data into a plurality of binary numbers; and
selecting at least one bit from at least a portion of the binary numbers to generate the one or more keys.

27. The method as set forth in claim 26 wherein the selecting further comprises:
determining a first set of least significant bits in the binary numbers with noise below a noise threshold;
determining a second set of most significant bits in the binary numbers which are not measurably random; and
determining a third set of one or more bits in each of the binary numbers which are measurably random based on the determination of the first set of least significant bits in the binary numbers with noise below a noise threshold and the second set of most significant bits in the binary numbers which are not measurably random, wherein the selecting at least one bit is selected from the determined third set.

28. The method as set forth in claim 1 further comprising identifying a presence of one of the devices with respect to another one of the devices, wherein the obtaining the data further comprises obtaining the data when the identifying signals the presence of one of the devices with respect to another one of the devices.

29. The method as set forth in claim 28 further comprising determining if there is adequate signal strength for the obtaining the data, wherein the obtaining the data further comprises obtaining the data when the signal strength is determined to be adequate.

30. The method as set forth in claim 1 further comprising synchronizing the devices before the obtaining the data.

31. The method as set forth in claim 1 further comprising one or more antennae at one or more of the one or more devices.

32. The method as set forth in claim 31 further comprising two or more antennae at one or more of the one or more devices.

33. The method as set forth in claim 32 wherein any two of the two or more antenna at one or more of the one or more devices are separated by a distance greater than the wavelength of the transmitted signal.

34. The method as set forth in claim 31 wherein the antenna are in motion during the key generation.

35. The method as set forth in claim 1 wherein the movement of the one or more devices is performed mechanically.

36. The method as set forth in claim 1 wherein the movement of the one or more devices is performed electro-mechanically.

37. The method as set forth in claim 1 wherein the processing is executed in software.

38. The method as set forth in claim 1 wherein the processing is executed in digital hardware.

39. The method as set forth in claim 38 wherein the digital hardware is one or more of an FPGA, CPLD, or ASIC.

40. A system for independently generating one or more keys at two or more devices, the system comprises:
a transmitting for transmitting a signal from the two or more devices;
a receiver at each device for receiving a signal transmitted from the other one or more different devices;
a data acquisition system at each of two or more devices, each of the data acquisition systems obtains data from the receiver based on movement of at least one of the devices with the respect to the other device; and
a key generation system that generates one or more keys based on the obtained data from each of the data acquisition systems for use in securing communications between the devices, wherein the one or more keys at each of the devices are substantially the same.

41. The system as set forth in claim 40 wherein each of the data acquisition systems obtains the data in response to movement of at least one of the devices with the respect to the other device during one or more passes between the devices.

42. The system as set forth in claim 40 wherein each of the data acquisition systems obtains the data during two or more passes between the devices.

43. The system as set forth in claim 40 wherein the obtained data comprises one of phase velocity and phase acceleration measurements.

44. The system as set forth in claim 40 wherein the frequency of the transmitted signal is unknown.

45. The system as set forth in claim 44 wherein the frequency of the transmitted signal is unknown but less than a maximum frequency.

46. The system as set forth in claim 40 wherein the transmitted signals from the two or more devices are interleaved in time.

47. The system as set forth in claim 40 further comprising a frequency generating system in each of the one or more devices.

48. The system as set forth in claim 47 wherein the transmitted signals from the two or more devices are substantially the same, wherein any frequency differences are caused by tolerances of the one or more of the frequency generating systems.

49. The system as set forth in claim 40 wherein the transmitted signal of one device is of a substantially different frequency than the frequency of the transmission of the other devices.

50. The system as set forth in claim 40 wherein the obtained data comprises phase measurements.

51. The system as set forth in claim 50 wherein the phase determining is made with a Discrete Fourier Transform.

52. The system as set forth in claim 51 wherein the Discrete Fourier Transform is a Fast Fourier Transform.

53. The system as set forth in claim 50 wherein the phase determining is made with a curve-fitting algorithm.

54. The system as set forth in claim 53 wherein the curve-fitting algorithm is a non-linear regression algorithm.

55. The system as set forth in claim 54 wherein the non-linear regression algorithm is a Gauss-Newton algorithm.

56. The method as set forth in claim 50 wherein the phase determining is made with a centroid determining algorithm.

57. The method as set forth in claim 50 wherein the phase determining is made with a zero-crossing determining algorithm.

58. The system as set forth in claim 40 wherein each of the data acquisition systems determine if the obtained data is less than a data threshold for generating the one or more keys, wherein each of the data acquisition systems obtains additional data if the obtained data is less than the data threshold.

59. The system as set forth in claim 40 further comprising an averaging system that averages one or more portions of the obtained data, wherein the key generation system generates the one or more keys based on the averaged portions of the obtained data.

60. The system as set forth in claim 40 further comprising a filtering system that filters the obtained data before the key generation system generates the one or more keys.

61. The system as set forth in claim 1 further comprising providing a local oscillator.

62. The system as set forth in claim 61 further comprises a multiplier that heterodynes the received signal with a signal from the local oscillator.

63. The system as set forth in claim 61 wherein the received signals and the local oscillator signal are substantially the same, wherein any frequency differences between the signals are caused by one or more of the tolerances of the one or more of the frequency generating systems and the tolerance of the frequency of the local oscillator.

64. The system as set forth in claim 40 wherein the key generation system further comprises:
a binary conversion system that converts the obtained data into a plurality of binary numbers; and
a selection system that selects at least one bit from at least a portion of the binary numbers to generate the one or more keys.

65. The system as set forth in claim 64 wherein the selection system further comprises:
a first determination system that determines a first set of least significant bits in the binary numbers with noise below a noise threshold;
a second determination system that determines a second set of most significant bits in the binary numbers which are not measurably random; and
a third determination system that determines a third set of one or more bits in each of the binary numbers which are measurably random based on the determination of the first set of least significant bits in the binary numbers with noise below a noise threshold and the second set of most significant bits in the binary numbers which are not measurably random, wherein the selection system selects at least one bit is selected from the determined third set.

66. The system as set forth in claim 40 further comprising an identification system that identifies a presence of one of the devices with respect to another one of the devices, wherein each of the data acquisition systems obtains the data when the identification system identifies the presence of one of the devices with respect to another one of the devices.

67. The system as set forth in claim 40 further comprising a signal determination system that determines if there is adequate signal strength for the obtaining the data, wherein each of the data acquisition systems obtains the data when the signal strength is determined to be adequate.

68. The system as set forth in claim 40 further comprising one or more antennae at one or more of the one or more devices.

69. The system as set forth in claim 68 further comprising two or more antennae at one or more of the one or more devices.

70. The system as set forth in claim 69 wherein any two of the two or more antenna at one or more of the one or more devices are separated by a distance greater than the wavelength of the transmitted signal.

71. The system as set forth in claim 69 wherein the antenna are in motion during the key generation.

72. The system as set forth in claim 40 further comprising a mechanical system for causing the motion of the one or more devices.

73. The system as set forth in claim 40 further comprising an electro-mechanical system for causing the motion of the one or more devices.

74. The system as set forth in claim 40 further comprising digital hardware wherein the processing is executed with the digital hardware.

75. The system as set forth in claim 74 wherein the digital hardware is one or more of an FPGA, CPLD, or ASIC.

76. The system as set forth in claim 40 further comprising a synchronization system that synchronizing the systems before each of the data acquisition systems obtains the data.

77. The system as set forth in claim 40 further comprising a conversion system that converts the obtained data into one or more converted parameters, wherein the key generation system generates the one or more keys based on the one or more converted parameters.
